(19) United States
(12) Patent Application Publication
(10) Pub. No.: US 2026/0102808 A1
(43) Pub. Date: Apr. 16, 2026

(54) Shear Assisted Extrusion Press Apparatus and Components

(71) Applicant: Atomic 13, LLC, San Diego, CA (US)

(72) Inventors: André Schulze, San Diego, CA (US); Felix Kolpak, San Diego, CA (US); Valentin Gala Losada, San Diego, CA (US); Hans-Jürgen Middelkamp, San Diego, CA (US); Malte Ringhandt, San Diego, CA (US)

(73) Assignee: Atomic 13, LLC, San Diego, CA (US)

(21) Appl. No.: 19/356,596

(22) Filed: Oct. 13, 2025

Related U.S. Application Data
(60) Provisional application No. 63/707,121, filed on Oct. 14, 2024.

(51) Int. Cl. B21C 26/00; B21C 23/00; F16C 19/54; F16C 32/06

(52) U.S. Cl. CPC B21C 26/00; B21C 23/00; F16C 19/545; F16C 32/064; F16C 2322/00

(57) ABSTRACT

The present disclosure provides a shear assisted extrusion press comprising a stem and plunger assembly comprising a main piston configured to generate an extrusion force, a stem assembly comprising a stem having a first end and a second end, wherein the second end connects to a rotary piston that connects to the stem and plunger assembly, wherein the main piston exerts the extrusion force on the stem such that the stem moves axially, and at least one piston motor coupled with the stem and configured to drive a rotational movement of the rotary piston and the stem, and a container assembly comprising a container holder, a container configured to receive a billet and the first end of the stem, and at least one hydraulic motor positioned in the container holder with the container, wherein the at least one hydraulic motor is configured to drive a rotational movement of the container. The rotary piston and the stem are configured to rotate and move axially such that the stem moves the billet through the container to extrude a part, and the container and the billet are configured to rotate together while the container does not move axially.

### CROSS-REFERENCE TO RELATED APPLICATIONS

This application claims priority to U.S. Provisional Patent Application No. 63/707,121, titled “Shear Assisted Extrusion Press Apparatus and Components”, filed Oct. 14, 2024, which is hereby incorporated by reference in its entirety.

### FIELD OF INVENTION

The present disclosure relates to metal extrusion systems, and more particularly to shear assisted direct extrusion presses that combine linear and rotational shear forces to enable commercial scale extrusion of metal billets including post-consumer scrap materials.

### BACKGROUND

Metal extrusion is a manufacturing process used to create objects of a fixed cross-sectional profile by pushing material through a die of the desired cross-section. In conventional extrusion processes, a billet of metal is placed in a container and forced through a die opening using a ram or plunger that applies axial force. The material flows plastically through the die opening, taking on the shape of the die profile to form the extruded product. This process is widely used in the production of rods, tubes, structural shapes, and complex profiles from various metals including aluminum, magnesium, copper, and steel alloys.

Shear assisted extrusion represents an advancement in metal forming technology that combines the conventional axial extrusion force with rotational shear forces applied simultaneously to the material. Unlike traditional extrusion methods that rely solely on linear compression, shear assisted extrusion incorporates rotational movement of either the die or the billet during the extrusion process. This rotational component introduces additional deformation mechanisms that create intense shear conditions at the interface between the material and the tooling. The combination of linear pressing and rotational shearing results in severe plastic deformation that occurs under different conditions than those found in conventional extrusion processes.

The unique deformation conditions created by shear assisted extrusion enable several distinctive capabilities in metal processing. The intense shear forces can refine the microstructure of metals, resulting in smaller grain sizes and improved mechanical properties compared to conventionally extruded materials. The process can also break down and redistribute intermetallic compounds and second-phase particles that may be present in the starting material, leading to more homogeneous microstructures. Additionally, shear assisted extrusion can process materials that may be difficult or impossible to extrude using conventional methods, including certain scrap materials and alloys with challenging flow characteristics. The process can operate at lower temperatures and forces than traditional extrusion while achieving superior material properties, making it applicable to a wide range of metalworking applications including automotive, aerospace, and structural components.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure provides a shear assisted extrusion press comprising a stem and plunger assembly that includes a main piston. The press includes a stem assembly having a stem with a first end and a second end, where the second end connects to a rotary piston that connects to the stem and plunger assembly. The main piston exerts an extrusion force on the stem such that the stem moves axially. At least one piston motor is coupled with the stem and configured to drive a rotational movement of the rotary piston and the stem. The press further includes a container assembly comprising a container holder, a container configured to receive a billet and the first end of the stem, and at least one hydraulic motor placed in the container holder with the container. The hydraulic motor is configured to drive a rotational movement of the container. The rotary piston and the stem are configured to rotate and move axially such that the stem moves the billet through the container to extrude a part, while the container and the billet are configured to rotate together while the container does not move axially.

The stem, rotary piston, and container may align concentrically. The stem assembly may comprise two piston motors and the container assembly may comprise two hydraulic motors. The container may be a multi-layer container. The container assembly may further comprise a heater configured to heat up the container, where the heater surrounds the container. The container may further comprise an interior heater. The billet that can be processed by the extrusion press may have a diameter of greater than or equal to 7 inches or greater than or equal to 9 inches. The billet may comprise metals such as aluminum, iron, copper, silicon, magnesium, manganese, zinc, chromium, nickel, titanium, and zirconium, or aluminum alloys including 3xxx series, 5xxx series, 6xxx series, 7xxx series, and 8xxx series aluminum alloys. The billet may comprise metallic materials in forms including powder, flake, scrap and solid. The extrusion force may be greater than or equal to 20 MN or greater than or equal to 35 MN. The part may be extruded through a stationary die assembly.

The disclosure also describes a shear assisted extrusion process involving loading a billet to a container assembly that comprises a container with an opening configured to receive the billet, and at least one hydraulic motor coupled with the container and configured to drive rotational movement of the container and billet. The process includes applying an extrusion force via a stem and plunger assembly comprising a main piston, and extruding a part from the billet by utilizing a stem assembly to push the billet axially. The stem assembly comprises a stem with first and second ends, where the second end connects to a rotary piston that connects to the stem and plunger assembly. The main piston exerts the extrusion force on the stem such that the stem moves axially. At least one piston motor coupled with the stem drives rotational movement of the rotary piston and stem. The rotary piston and stem rotate and move axially such that the stem moves the billet through the container to extrude the part, while the container and billet rotate together while the container does not move axially.

The process may involve components that align concentrically, use multiple motors, employ multi-layer containers, and include heating of the container via interior or surrounding heaters. The process may use billets with diameters of 7 inches or greater, use various metal billets and alloy compositions, apply extrusion forces, involve clamping the billet between a die and dummy block where the stem connects with the dummy block, and extrude the part through a stationary die assembly. The extruded parts can have various dimensions depending on the desired applications. In certain embodiments, the extruded parts can have a diameter greater than or equal to about 2 inches. The applied extrusion forces can vary depending on the billet material, temperature, extrudes geometries, and/or process parameters. In some embodiments, the extrusion forces can be greater than or equal to about 20 MN. In some embodiments, the extrusion forces can be less than about 20 MN.

Some embodiments include a shear assisted extrusion press, comprising: a stem and plunger assembly comprising a main piston configured to generate an extrusion force; a stem assembly comprising a stem having a first end and a second end, wherein the second end connects to a rotary piston that connects to the stem and plunger assembly, wherein the main piston exerts the extrusion force on the stem such that the stem moves axially, and at least one piston motor coupled with the stem and configured to drive a rotational movement of the rotary piston and the stem; a container assembly comprising a container holder, a container configured to receive a billet and the first end of the stem, and at least one hydraulic motor positioned in the container holder with the container, wherein the at least one hydraulic motor is configured to drive a rotational movement of the container; wherein the rotary piston and the stem are configured to rotate and move axially such that the stem moves the billet through the container to extrude a part, and wherein the container and the billet are configured to rotate together while the container does not move axially.

In some embodiments, the stem, the rotary piston, and the container align concentrically.

In some embodiments, the at least one piston motor comprises two piston motors and the at least one hydraulic motor comprises two hydraulic motors.

In some embodiments, the container is a multi-layer container.

In some embodiments, the multi-layer container comprises three layers.

In some embodiments, the multi-layer container is constructed from a tool steel selected from the group consisting of hot-work tool steel, H13 steel, and H11 steel.

In some embodiments, the container assembly further comprises a heater configured to heat the container, wherein the heater surrounds the container.

In some embodiments, the container further comprises an interior heater.

In some embodiments, the shear assisted extrusion press further comprises a heater plug configured to activate the interior heater.

In some embodiments, the extrusion force is greater than or equal to 20 MN.

In some embodiments, the extrusion force is greater than or equal to 35 MN.

In some embodiments, the part has a diameter of greater than or equal to 7 inches.

In some embodiments, the part has a diameter of greater than or equal to 9 inches.

In some embodiments, the shear assisted extrusion press further comprises a hydraulic bearing positioned within the container assembly and configured to provide support for rotating components during operation.

In some embodiments, the shear assisted extrusion press further comprises a sealing ring positioned to prevent fluid leakage between adjacent surfaces while accommodating both axial and rotational motion.

In some embodiments, the at least one hydraulic motor is a radial piston motor configured to generate a maximum torque of 120,000 Nm.

In some embodiments, the shear assisted extrusion press further comprises a gear unit positioned between the radial piston motor and the container, wherein the gear unit is configured to transmit rotational motion from the radial piston motor to the container.

In some embodiments, the main piston has a hollow cavity configured to contain lubricating fluids to transfer a pressure of the extrusion force.

In some embodiments, the shear assisted extrusion press further comprises a dummy block positioned between the first end of the stem and the billet.

In some embodiments, the shear assisted extrusion press further comprises a die, wherein the billet is pushed through the container via the stem and through the die to extrude the part.

Some embodiments include an axial stem bearing system for a shear assisted extrusion press, comprising: a rotary piston configured to rotate while transmitting axial forces during extrusion operations; a thrust bearing positioned to accommodate the axial forces transmitted through the rotary piston, wherein the axial forces are configured to enable an axial motion of the rotary piston; a hydraulic bearing configured to provide support and positioning while maintaining controlled separation between rotating and stationary components using pressurized fluid; and a plurality of roller bearings arranged to provide radial support and positioning for the rotary piston while enabling a rotational motion under load, wherein the thrust bearing, the hydraulic bearing, and the plurality of roller bearings operate in coordination to provide comprehensive support for the rotary piston during simultaneous axial and rotational motion.

In some embodiments, the hydraulic bearing utilizes pressurized lubricating fluid to maintain controlled clearances between the rotary piston and adjacent stationary components.

In some embodiments, the pressurized lubricating fluid maintains consistent clearances even as loading conditions vary during extrusion operations.

In some embodiments, the thrust bearing is configured to accommodate axial forces greater than or equal to 20 MN.

In some embodiments, the thrust bearing is configured to accommodate axial forces greater than or equal to 35 MN.

In some embodiments, the plurality of roller bearings are arranged to distribute radial loads across multiple contact points to reduce contact stresses.

In some embodiments, the plurality of roller bearings remain stationary and provide sealing functions that separate the rotary piston from lubricating fluids.

In some embodiments, the rotary piston is configured to rotate while the thrust bearing remains stationary during extrusion operations.

In some embodiments, rotating parts including the rotary piston and hydraulic bearing operate independently of stationary parts including the roller bearings and thrust bearing.

In some embodiments, the hydraulic bearing is configured to create a dynamic and self-correcting separation between rotating and stationary components.

In some embodiments, the hydraulic bearing maintains separation through pressurized fluid that adjusts to varying load conditions during operation.

In some embodiments, the thrust bearing provides a load-bearing interface between hydraulic force generation components and rotating elements of the system.

In some embodiments, the thrust bearing enables transmission of axial forces while accommodating rotational motion of the rotary piston.

In some embodiments, the plurality of roller bearings are positioned to maintain the rotary piston in proper axial and radial alignment during rotational motion under load.

In some embodiments, the plurality of roller bearings enable smooth rotational motion while providing structural support necessary to maintain proper alignment under substantial forces generated during commercial-scale extrusion processing.

In some embodiments, the coordinated operation of the thrust bearing, the hydraulic bearing, and the plurality of roller bearings facilitates simultaneous handling of substantial axial loads and rotational torques while maintaining precision and control necessary for effective shear assisted extrusion processing.

In some embodiments, the bearing system maintains operational reliability and longevity under the complex loading conditions associated with commercial-scale direct extrusion operations.

In some embodiments, the shear assisted extrusion press extrudes a part with a diameter of greater than or equal to 7 inches.

In some embodiments, the axial forces are greater than or equal to 20 MN.

Some embodiments include a stem fastening system for a shear assisted extrusion press, comprising: a front plate configured to receive and distribute axial forces generated during extrusion operations; a bayonet ring mechanically coupled to the front plate; a plurality of fastening pins extending through the front plate and the bayonet ring; a plurality of hexagon nuts threaded onto the fastening pins to provide adjustable clamping force; a base plate mechanically attached to the bayonet ring; a plurality of socket head bolts extending through the base plate; and a plurality of fitting keys positioned to provide rotational coupling between the base plate and a rotary piston, wherein the stem fastening system enables transmission of both axial forces and rotational torques to an extrusion stem during shear assisted extrusion operations.

In some embodiments, the front plate is configured to distribute axial forces greater than or equal to 20 MN across a wide contact area.

In some embodiments, the front plate is configured to distribute axial forces greater than or equal to 35 MN.

In some embodiments, the bayonet ring is configured to interface with the extrusion stem through a bayonet-style coupling mechanism that provides secure attachment while enabling controlled engagement and disengagement procedures.

In some embodiments, the bayonet-style coupling mechanism enables rapid and reliable engagement and disengagement procedures while providing mechanical strength for commercial-scale shear assisted direct extrusion operations.

In some embodiments, the plurality of fastening pins and hexagon nuts provide adjustable clamping force that secures mechanical connection while enabling precise control over assembly preload conditions.

In some embodiments, the fastening pins extend through corresponding openings in the front plate and the bayonet ring to establish positive mechanical engagement between the components.

In some embodiments, the base plate serves as an intermediate structural element that facilitates mechanical interface between stem fastening components and rotational drive systems.

In some embodiments, the base plate is positioned to receive and distribute combined axial and rotational forces transmitted through the bayonet ring during extrusion operations.

In some embodiments, the plurality of socket head bolts are threaded into corresponding openings in the rotary piston to establish secure axial coupling.

In some embodiments, the socket head bolts accommodate the fitting keys that provide rotational constraint between the base plate and the rotary piston.

In some embodiments, the plurality of fitting keys are positioned within corresponding keyways in the base plate and the rotary piston to prevent relative rotational motion between the components.

In some embodiments, the fitting keys enable coordinated transmission of torque from a rotational drive system to the extrusion stem while maintaining proper axial alignment during operation.

In some embodiments, the stem fastening system further comprises a retaining ring attached to the base plate to provide additional structural support and positioning functions.

In some embodiments, the retaining ring serves as a backup retention mechanism that maintains proper component positioning under varying load conditions during commercial-scale extrusion operations.

In some embodiments, the stem fastening system is configured to operate between an unlocked position and a locked position corresponding to different operational states.

In some embodiments, in the unlocked position the bayonet ring allows relative movement between the extrusion stem and the stem fastening system to enable insertion, removal, or repositioning of the extrusion stem during setup or maintenance procedures, and in the locked position the bayonet ring provides secure mechanical coupling between the extrusion stem and rotational drive components during extrusion processing.

Some embodiments include a container assembly for a shear assisted extrusion press, comprising: a container holder providing structural support and positioning functions; a container positioned within the container holder and configured to receive a billet, wherein the container is configured to rotate relative to the container holder while maintaining axial positioning; at least one radial piston motor positioned within the container holder and configured to generate rotational forces for rotating the container; a gear unit mechanically coupled to the at least one radial piston motor and configured to transmit rotational motion to the container; a container bearing system configured to facilitate rotational motion of the container while accommodating substantial loads; and a sealing system positioned at interfaces between the container and adjacent components to prevent material leakage while accommodating rotational motion of the container.

In some embodiments, the container is a multi-layer container.

In some embodiments, the multi-layer container comprises at least three layers.

In some embodiments, the multi-layer container is constructed from a tool steel selected from the group consisting of hot-work tool steel, H13 steel, and H11 steel.

In some embodiments, the at least one radial piston motor comprises two radial piston motors positioned within the container holder.

In some embodiments, each of the two radial piston motors is configured to generate a maximum torque of 120,000 Nm.

In some embodiments, the gear unit comprises multiple gear stages configured to provide mechanical advantage and controlled rotational speed characteristics.

In some embodiments, the gear unit incorporates reduction ratios that enable optimization of torque and speed characteristics for different processing conditions and billet materials.

In some embodiments, the container bearing system comprises a hydrostatic axial bearing configured to accommodate extrusion forces greater than or equal to 20 MN while maintaining rotational capability.

In some embodiments, the extrusion forces are greater than or equal to 35 MN.

In some embodiments, the hydrostatic axial bearing utilizes pressurized fluid to create controlled separation between rotating and stationary components.

In some embodiments, the pressurized fluid maintains consistent bearing clearances even as loading conditions vary during extrusion operations.

In some embodiments, the container assembly further comprises a heating system integrated within the container holder and configured to provide thermal conditioning of the container and the billet.

In some embodiments, the heating system comprises an interior heater positioned within the container and an external heater surrounding the container.

In some embodiments, the container assembly further comprises a heater plug configured to enable manual activation and deactivation of the interior heater during preheating and processing operations.

In some embodiments, the container assembly further comprises thermocouples to monitor temperatures of the container and the billet.

In some embodiments, the sealing system comprises a seal gap maintained at a constant distance between the container and adjacent stationary components to prevent material leakage while accommodating rotational motion.

In some embodiments, the sealing system further comprises wear rings fabricated from iron-nickel alloys configured to withstand temperatures greater than or equal to 600° C.

In some embodiments, the container is configured to accommodate billets with lengths ranging from about 400 mm to about 1300 mm and diameters of 7 inches or greater.

In some embodiments, the container holder includes centering devices and swivel pinions configured to maintain proper alignment between the container and an extrusion stem during rotational motion.

Some embodiments include a hydrostatic container bearing system for a shear assisted extrusion press, comprising: a first bearing surface associated with a rotating container component; a second bearing surface associated with a stationary structural component; a pressurized fluid system configured to introduce pressurized fluid between the first bearing surface and the second bearing surface to establish a fluid film that separates the rotating container component from the stationary structural component; a fluid supply system comprising pumps and pressure regulators configured to maintain controlled pressure and flow characteristics of the pressurized fluid; and a plurality of fluid distribution channels arranged to provide uniform load distribution and consistent separation between the first bearing surface and the second bearing surface during operation, wherein the hydrostatic container bearing system accommodates extrusion forces while enabling rotational motion of the container component.

In some embodiments, the extrusion forces accommodated by the system are greater than or equal to 20 MN.

In some embodiments, the extrusion forces accommodated by the system are greater than or equal to 35 MN.

In some embodiments, the pressurized fluid system maintains fluid pressure at levels that correspond to the magnitude of axial forces being transmitted through a container assembly.

In some embodiments, the fluid film established by the pressurized fluid system provides both load-bearing capabilities and lubrication functions that facilitate smooth rotational motion under substantial force conditions.

In some embodiments, the first bearing surface and the second bearing surface are configured with specialized geometries that optimize fluid flow patterns and pressure distribution characteristics.

In some embodiments, the bearing surfaces incorporate recessed pockets and grooves that facilitate fluid retention and pressure maintenance while accommodating rotational motion.

In some embodiments, the fluid supply system further comprises flow control valves configured to enable real-time adjustment of bearing operating parameters.

In some embodiments, the fluid supply system includes feedback mechanisms that monitor bearing performance parameters including fluid pressure, flow rate, and bearing clearance.

In some embodiments, the feedback mechanisms enable automatic adjustment of operating conditions and early detection of potential bearing system issues.

In some embodiments, the plurality of fluid distribution channels are arranged to provide controlled fluid flow to multiple bearing zones for localized pressure control.

In some embodiments, the fluid distribution channels enable enhanced load distribution capabilities across a bearing interface between the first bearing surface and the second bearing surface.

In some embodiments, the pressurized fluid is selected to provide stable viscosity and lubrication properties across a temperature range associated with extrusion operations.

In some embodiments, the hydrostatic container bearing system further comprises temperature control features configured to maintain pressurized fluid temperature within optimal operating ranges.

In some embodiments, the temperature control features accommodate heat generation resulting from friction, fluid shear, and thermal conduction from adjacent heated components.

In some embodiments, the hydrostatic container bearing system is configured to distribute axial loads across multiple bearing zones to reduce localized stress concentrations.

In some embodiments, the system incorporates automatic load balancing and pressure adjustment features that respond to varying force conditions to maintain optimal bearing performance.

Some embodiments include a sealing and wear ring system for a shear assisted extrusion press, comprising: a centering ring configured to provide alignment and positioning functions for die components relative to a rotating container; a second centering ring, wherein the centering ring is positioned within the second centering ring; a retaining ring configured to provide secure attachment of the centering ring to a container holder; a tool holder positioned to provide structural support for die components; a seal gap maintained between the rotating container and the tool holder to provide controlled separation while minimizing material leakage pathways; and a plurality of wear rings fabricated from iron-nickel alloys and configured to withstand temperatures greater than 600° C., wherein the sealing and wear ring system prevents molten metal flow between rotating and stationary components during extrusion operations.

In some embodiments, the centering ring is shrink-fitted within the second centering ring to establish a secure mechanical coupling that maintains proper positioning and alignment during varying load conditions.

In some embodiments, the shrink-fit arrangement between the centering ring and the second centering ring provides enhanced structural stability while enabling coordinated positioning of sealing components relative to the rotating container.

In some embodiments, the centering ring serves to center the tool holder relative to the rotating container, thereby maintaining proper alignment between die components and contained billet material during processing operations.

In some embodiments, the tool holder is configured to accommodate various die geometries and configurations while maintaining proper sealing performance at the interface with the rotating container.

In some embodiments, the seal gap is dimensioned to provide adequate clearance for rotational motion while minimizing the pathway available for molten metal flow between the rotating container and adjacent die components.

In some embodiments, the seal gap maintains a constant distance throughout an extrusion cycle, thereby providing consistent sealing performance while accommodating thermal expansion and mechanical deformation during extrusion operations.

In some embodiments, the sealing and wear ring system further comprises bearings that provide additional support and positioning functions contributing to maintenance of proper seal gap dimensions during operation under substantial loads.

In some embodiments, the plurality of wear rings are configured in radial sealing arrangements that provide sealing functions through radial contact or proximity between rotating and stationary components.

In some embodiments, the radial sealing arrangements accommodate different container diameters and die geometries while maintaining effective sealing performance under substantial pressures and temperatures associated with commercial-scale extrusion processing.

In some embodiments, the container diameter is greater than or equal to 7 inches.

In some embodiments, the plurality of wear rings are configured in conical sealing arrangements that utilize angled or tapered interfaces between rotating and stationary components to achieve effective sealing performance.

In some embodiments, the conical sealing arrangements accommodate rotational motion of the rotating container while providing enhanced sealing effectiveness through the angled interface geometry.

In some embodiments, the iron-nickel alloys of the plurality of wear rings provide enhanced thermal stability and mechanical strength characteristics that enable the wear rings to maintain dimensional stability and sealing effectiveness when exposed to molten aluminum during extrusion processing.

In some embodiments, the iron-nickel alloy composition enables extended operational life and reduced maintenance requirements compared to wear rings fabricated from conventional materials.

In some embodiments, the retaining ring serves as a mechanical fastening element that maintains the position of the centering ring while accommodating thermal expansion and mechanical deformation during high-temperature extrusion operations.

In some embodiments, the retaining ring provides secure attachment of the centering ring to the container holder, thereby establishing a structural foundation for sealing system operation.

In some embodiments, the sealing and wear ring system operates in coordination with bearing systems and structural support elements to provide comprehensive containment and positioning functions that enable reliable operation under demanding conditions associated with commercial-scale extrusion operations.

Some embodiments include a shear assisted direct extrusion process, comprising: loading a billet into a container assembly comprising a container with an opening configured to receive the billet and at least one hydraulic motor coupled with the container; applying an extrusion force via a stem and plunger assembly comprising a main piston; extruding a part from the billet by operating a stem assembly comprising a stem with a first end and a second end, wherein the second end connects to a rotary piston that connects to the stem and plunger assembly, wherein the main piston exerts the extrusion force on the stem such that the stem moves axially, and at least one piston motor coupled with the stem drives rotational movement of the rotary piston and the stem; wherein the rotary piston and the stem rotate and move axially such that the stem moves the billet through the container to extrude the part; and wherein the container and the billet rotate together while the container does not move axially.

In some embodiments, the stem, the rotary piston, and the container align concentrically.

In some embodiments, the at least one piston motor comprises two piston motors and the at least one hydraulic motor comprises two hydraulic motors.

In some embodiments, the container is a multi-layer container.

In some embodiments, the multi-layer container comprises three layers constructed from a tool steel selected from the group consisting of hot-work tool steel, H13 steel, and H11 steel.

In some embodiments, the shear assisted direct extrusion process further comprises heating the container via an interior heater positioned within the container.

In some embodiments, the shear assisted direct extrusion process further comprises activating the interior heater via a heater plug during preheating operations and deactivating the interior heater during active extrusion processing.

In some embodiments, the shear assisted direct extrusion process further comprises heating the container via an external heater surrounding the container within the container assembly.

In some embodiments, the extrusion force is greater than or equal to 20 MN.

In some embodiments, the extrusion force is greater than or equal to 35 MN.

In some embodiments, the part has a diameter of greater than or equal to 7 inches.

In some embodiments, the part has a diameter of greater than or equal to 9 inches.

In some embodiments, the billet comprises a metal selected from the group consisting of aluminum, iron, copper, silicon, magnesium, manganese, zinc, chromium, nickel, titanium, and zirconium.

In some embodiments, the billet comprises an aluminum alloy selected from the group consisting of a 3xxx series aluminum alloy, a 5xxx series aluminum alloy, a 6xxx series aluminum alloy, a 7xxx series aluminum alloy, and an 8xxx series aluminum alloy.

In some embodiments, the billet comprises a metallic material in a form selected from the group consisting of powder, flake, scrap, and solid.

In some embodiments, the shear assisted direct extrusion process further comprises clamping the billet between a die and a dummy block, wherein the first end of the stem connects with the dummy block.

In some embodiments, the shear assisted direct extrusion process further comprises extruding the part through a stationary die assembly.

In some embodiments, the shear assisted direct extrusion process further comprises removing the die assembly and separating the extruded part from remaining billet material while maintaining rotational motion of both the stem assembly and the container assembly during retraction to facilitate a clean separation of the extruded part.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF FIGURES

The description will be more fully understood with reference to the following figures, which are presented as embodiments of the invention and should not be construed as a complete recitation of the scope of the invention, wherein:

FIG. 1 illustrates a direct extrusion process without shear assistance, according to aspects of the present disclosure.

FIG. 2 illustrates an indirect extrusion process without shear assistance in accordance with the prior art.

FIG. 3A illustrates a shear assisted indirect extrusion process, according to aspects of the present disclosure.

FIG. 3B illustrates a shear assisted direct extrusion process, according to aspects of the present disclosure.

FIG. 3C illustrates temperature comparison between direct extrusion and shear assisted direct extrusion, according to aspects of the present disclosure.

FIG. 3D illustrates plastic strain comparison between direct extrusion and shear assisted direct extrusion, according to aspects of the present disclosure.

FIG. 4A illustrates a perspective view of a shear-assisted direct extrusion press, according to an embodiment.

FIG. 4B illustrates a front cross-sectional view of the shear assisted direct extrusion press of FIG. 4A, according to an embodiment.

FIG. 4C illustrates a cross-sectional view of the shear assisted direct extrusion press of FIG. 4B, according to an embodiment.

FIG. 5 illustrates a portion of the shear-assisted direct extrusion press of FIG. 4A, according to an embodiment.

FIG. 6A illustrates a cross-sectional view of a stem and plunger assembly, according to an embodiment.

FIG. 6B illustrates a top view of the stem and plunger assembly of FIG. 6A, according to an embodiment.

FIG. 6C illustrates an interior view of the stem and plunger assembly of FIG. 6A, according to an embodiment.

FIG. 6D illustrates a profile view of a stem drive and stem assembly, according to an embodiment.

FIG. 6E illustrates a profile view of the stem drive and stem assembly of FIG. 6D, according to an embodiment.

FIG. 6F illustrates a cross-sectional view of the stem drive of FIG. 6D, according to an embodiment.

FIG. 6G illustrates a profile view of hydraulic rotary piston motors and a gear wheel, according to an embodiment.

FIG. 6H illustrates a combined bearing system for a stem assembly, according to an embodiment.

FIG. 7A illustrates a stem fastening system in an exploded view configuration, according to an embodiment.

FIG. 7B illustrates a profile view of a cross section of the stem fastening system of FIG. 7A, according to an embodiment.

FIG. 7C illustrates a profile view of a cross section of the stem fastening system of FIG. 7A, according to an embodiment.

FIG. 8A illustrates a perspective view of a container assembly, according to an embodiment.

FIG. 8B illustrates a profile view of the container holder and container of FIG. 8A, according to an embodiment.

FIG. 9A illustrates a profile view of the container holder of FIG. 8A, according to an embodiment.

FIG. 9B illustrates a profile cross-sectional view of the container holder of FIG. 8A, according to an embodiment.

FIG. 9C illustrates a profile cross-sectional view of the container assembly of FIG. 8A, according to an embodiment.

FIG. 10 illustrates a sealing and wear ring system, according to an embodiment.

FIG. 11 illustrates a hydrostatic axial bearing assembly system, according to an embodiment.

FIG. 12 illustrates schematics of a shear-assisted direct extrusion process, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

It will be understood that the components of the embodiments, as generally described herein and illustrated in the appended figures, may be arranged and designed in a variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages and similar language throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may but do not necessarily, all refer to the same embodiment.

Shear assisted direct extrusion represents an advanced metal forming process that combines conventional linear extrusion forces with rotational shear forces to achieve enhanced material properties and processing capabilities. In some cases, this combination of forces may enable the processing of materials that would otherwise be unsuitable for conventional extrusion methods. The simultaneous application of axial and rotational forces during the extrusion process may result in severe plastic deformation of the feedstock material, leading to microstructural refinement and improved mechanical properties in the final extruded product.

The integration of rotational shear forces with linear extrusion forces may provide several processing advantages over conventional extrusion methods. In some cases, the rotational component may generate frictional heating at the interface between the feedstock and the extrusion die, which may soften the material and reduce the overall force requirements for extrusion. The severe deformation induced by the combined forces may also result in grain refinement and homogenization of the material microstructure. Additionally, the shear forces may break down and redistribute intermetallic compounds that are commonly present in recycled or scrap materials, potentially enabling the use of lower-grade feedstocks to produce high-quality extruded products.

Direct extrusion processes, as distinguished from indirect extrusion processes, may offer certain advantages for commercial-scale manufacturing applications. In direct extrusion, the container remains stationary while the ram moves axially to push the billet through the die. This configuration may allow for larger extrusion profiles and more complex geometries compared to indirect extrusion systems. However, direct extrusion may also introduce additional challenges, including increased friction between the billet and container walls, higher force requirements, and the need for more robust container designs to withstand the increased loads.

The apparatus disclosed herein may address various technical challenges associated with implementing shear assisted direct extrusion at commercial scales. In some cases, the apparatus may incorporate specialized bearing systems to handle the combined axial and rotational loads during operation. The container assembly may be designed to rotate while maintaining proper sealing and alignment with the die assembly. The stem and plunger systems may be configured to transmit both axial forces and rotational torque to the billet material. Various sealing and wear protection systems may be implemented to prevent material leakage and component wear during the high-force, high-temperature extrusion process.

The feedstock materials processed using shear assisted direct extrusion may include various forms of metallic materials, including powders, flakes, scrap materials, metal matrix composite feedstocks, metal matrix composite precursors, and solid billets. In some cases, the process may be particularly suitable for aluminum alloys and other non-ferrous metals. The ability to process scrap and recycled materials may provide environmental and economic benefits by reducing waste and enabling the production of high-quality extruded products from lower-grade feedstocks. The microstructural refinement achieved through the shear assisted process may result in extruded products with improved strength, ductility, and other mechanical properties compared to conventional extrusion methods.

Conventional extrusion processes may be categorized into two primary modes of operation: direct extrusion and indirect extrusion. These processes differ fundamentally in the relative movement of components and the manner in which forces are applied to the billet material during forming operations. Understanding the distinctions between these conventional approaches may provide context for the enhanced capabilities offered by shear assisted extrusion systems.

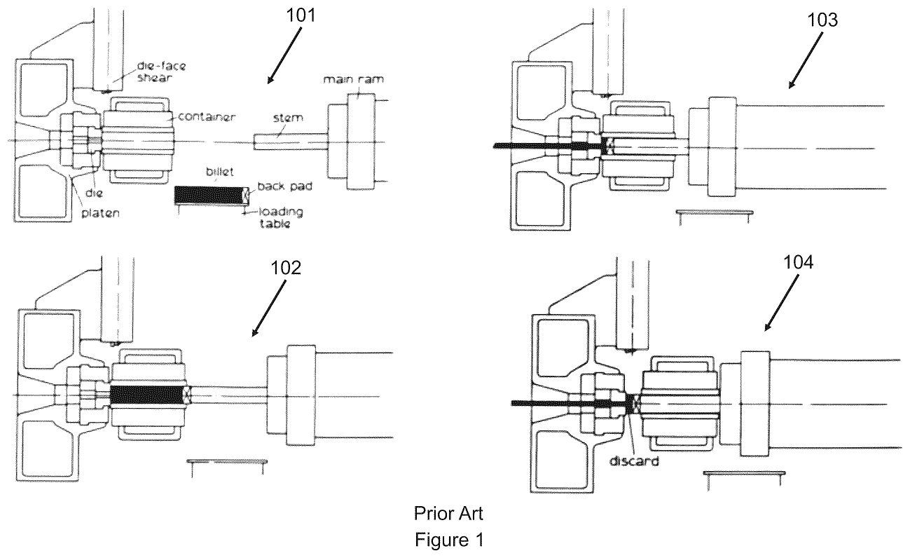

Referring to FIG. 1, direct extrusion processes without shear assistance may involve the axial movement of a billet within a stationary container. In some cases, the billet may be positioned between a die assembly and a ram system, with the container remaining fixed in position during the extrusion operation. The ram may apply axial force to push the billet through the die opening, causing material flow and deformation. During this process, friction may develop between the outer surface of the billet and the inner walls of the container as the billet material moves relative to the container. The magnitude of this friction may depend on various factors including the billet material properties, container surface conditions, processing temperature, and the presence or absence of lubricants.

The direct extrusion process may include several operational stages that facilitate material handling and processing. In some cases, the process may begin with loading the billet and associated components into the press assembly 101. The extrusion operation may then proceed with the application of axial force to deform the billet material through the die opening 102. Following the completion of material flow, the press may undergo decompression and the container may be opened to expose any remaining material or discard portions 103. The process may conclude with the removal of discard material and the return of press components to their initial loading positions for subsequent operations 104.

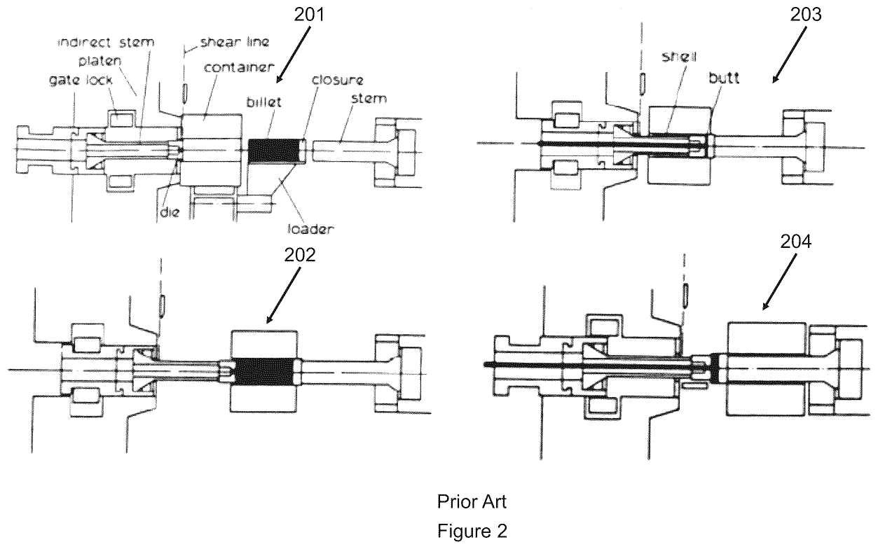

With reference to FIG. 2, indirect extrusion processes may operate under different kinematic conditions compared to direct extrusion systems. In indirect extrusion configurations, relative movement may occur between the die assembly and the container, while the billet material may remain substantially stationary relative to the container walls. This arrangement may result in reduced friction between the billet and container surfaces since there may be minimal relative motion between these components during the extrusion process. The die assembly may move relative to the billet and container, causing material flow through the die opening without significant sliding contact between the billet and container walls.

The indirect extrusion process may involve several distinct operational phases that differ from direct extrusion procedures. In some cases, the process may begin with the loading of die components and the positioning of the billet material within the container 201 and 202. The extrusion operation may proceed through the relative movement of the die assembly, which may cause material deformation and flow 203. Upon completion of the extrusion process, the die assembly may be separated from the extruded material and any remaining discard portions 204. The reduced friction characteristics of indirect extrusion may result in lower force requirements compared to direct extrusion processes, particularly for longer billets where friction effects may be more pronounced.

The choice between direct and indirect extrusion modes may involve various technical and practical considerations. Direct extrusion processes may offer advantages in terms of the range of achievable extrusion profiles and the overall diameter of the circumscribing circle available for the extruded product. However, direct extrusion may also require higher forces due to friction effects, and these force requirements may increase with billet length. Indirect extrusion processes may provide benefits in terms of reduced friction and lower force requirements, but may face limitations in ram construction complexity and the range of achievable product geometries. The selection of an appropriate extrusion mode may depend on the specific requirements of the intended application, including product geometry, material properties, and production volume considerations.

Shear assisted extrusion processes may incorporate rotational movement or rotational components during the extrusion operation, distinguishing these methods from conventional extrusion approaches that rely solely on axial forces. The introduction of rotational shear forces during extrusion may enable the modification and reformation of the underlying atomic structure of metallic materials through severe plastic deformation mechanisms. In some cases, the combined application of axial and rotational forces may result in dynamic recrystallization, grain boundary migration, and the redistribution of alloying elements within the material matrix. This microstructural evolution may enable the processing of lower-grade feedstock materials, including recycled or scrap materials, to produce extruded products with mechanical properties comparable to those achieved using virgin materials. The ability to tailor and control the atomic structure of extruded parts through shear assisted processing may provide opportunities for creating materials with enhanced strength, ductility, corrosion resistance, or other desired properties.

The microstructural modifications achieved through shear assisted extrusion may depend on various processing parameters that influence the deformation mechanisms and material flow patterns. In some cases, the rotational speed of shear elements, the feed rate of the billet material, processing temperature, extrusion ratio, and the dimensions of both the billet and the desired extrusion profile may affect the degree of microstructural refinement. The severe deformation conditions generated by the combination of axial and rotational forces may promote the breakdown of coarse intermetallic phases, the homogenization of compositional variations, and the refinement of grain structures. These microstructural changes may result in improved mechanical properties and may enable the use of feedstock materials that would otherwise be unsuitable for conventional extrusion processes due to compositional inhomogeneities or the presence of brittle intermetallic compounds.

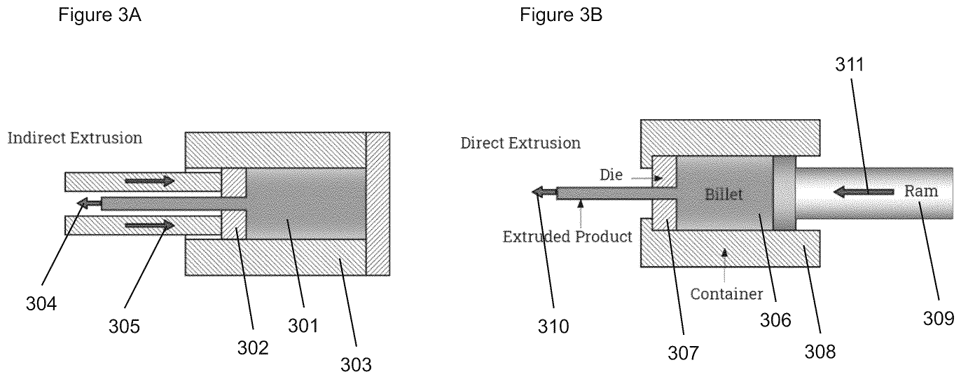

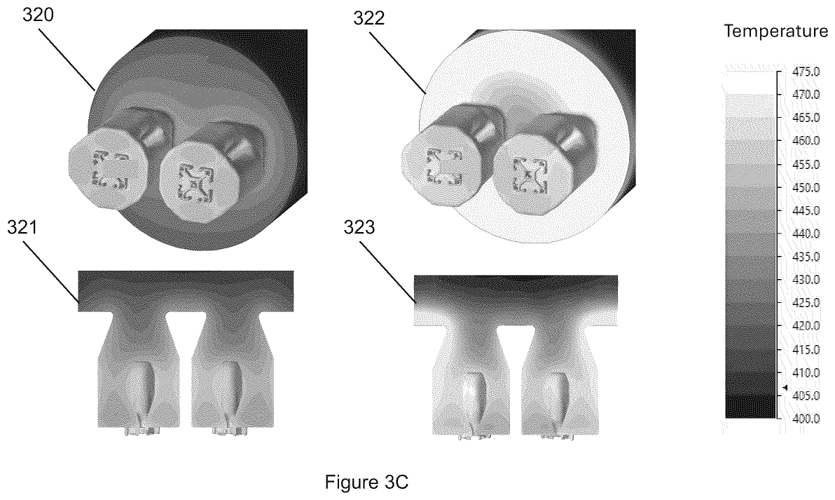

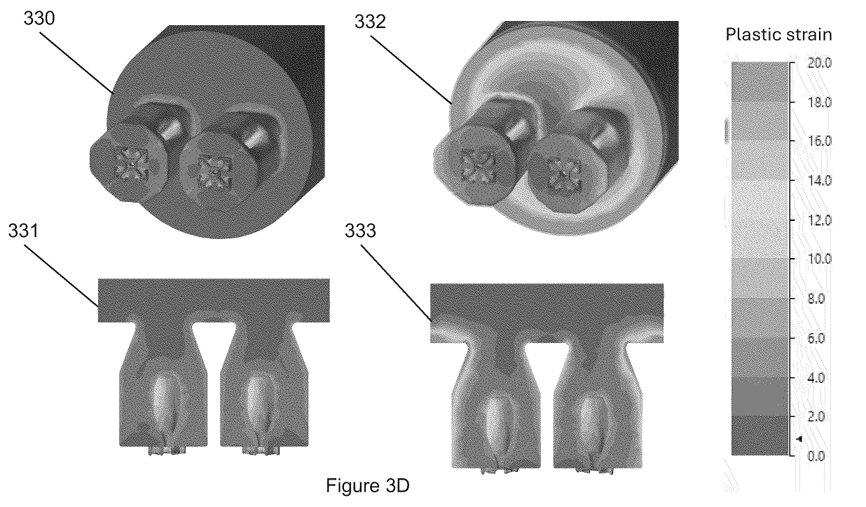

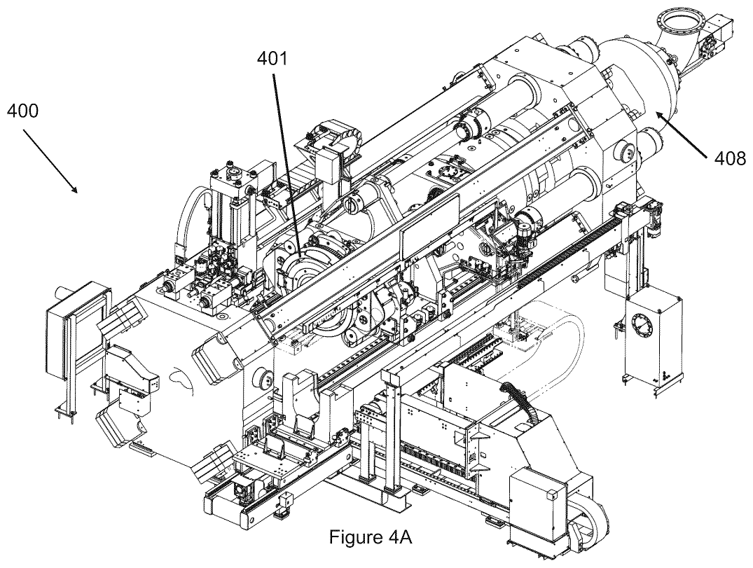

Referring to FIGS. 3A and 3B, shear assisted extrusion processes may be implemented in both indirect and direct configurations, each presenting distinct operational characteristics and performance capabilities. FIG. 3A illustrates a shear assisted indirect extrusion process where a billet 301 may be positioned within a container system and forced into an extrusion die 302. In the indirect configuration, the billet 301 and container 303 may rotate together such that minimal relative motion occurs between the billet 301 and the container 303 walls during the extrusion process. A first ram rotation may be applied to the billet 301 while a first ram speed controls the axial movement of the material through the extrusion die 302. The rotational component may generate frictional heating at the interface between the billet 301 and the extrusion die 302, which may soften the material and facilitate material flow through the die opening. In indirect extrusion, the material flow 304 is in the opposite direction to the die and/or ram movement direction 305.

With continued reference to FIGS. 3A and 3B, the direct shear assisted extrusion configuration shown in FIG. 3B may operate under different kinematic conditions compared to the indirect process. In the direct configuration, a second billet 306 may be processed through a second extrusion die 307 while the container 308 remains stationary in the axial direction. A second ram 309 rotation may be applied to induce rotational shear forces while a second ram speed controls the axial progression of the extrusion process. The container 308 may rotate to impart shear forces to the second billet 306, but the container may not move axially during the extrusion operation. This configuration may result in increased friction forces between the second billet 306 and the container 308 walls due to the relative motion between these components during material flow. In direct extrusion, the material flow 310 is in the same direction as the ram movement direction 311.

Referring to FIG. 3C, shear assisted extrusion processes may generate higher temperature compared to direct extrusion. 320 illustrates a temperature distribution of a die face and extruded parts from a direct extrusion. 321 illustrates the temperature distribution in 320 from a top view. 322 illustrates a temperature distribution of a die face and extruded parts from a shear assisted direct extrusion. 323 illustrates the temperature distribution in 322 from a top view. The shear assisted direct extrusion generates a higher temperature at the die and the extruded parts.

Referring to FIG. 3D, shear assisted extrusion processes may generate higher plastic strain compared to direct extrusion. 330 illustrates a plastic strain distribution of a die face and extruded parts from a direct extrusion. 331 illustrates the plastic strain distribution in 330 from a top view. 332 illustrates a plastic strain distribution of a die face and extruded parts from a shear assisted direct extrusion. 333 illustrates the plastic strain distribution in 332 from a top view. The shear assisted direct extrusion generates a higher plastic strain at the die and the corners of the extruded parts.

The indirect shear assisted extrusion process may present certain limitations that may restrict its applicability for commercial-scale manufacturing operations. In some cases, the indirect configuration may limit the maximum size of extruded products due to structural constraints associated with the die mounting system. The extrusion die 103 in indirect systems may be mounted on a hollow shaft or spindle that must possess adequate structural rigidity to withstand the applied forces without failure. This structural requirement may impose limitations on the available diameter for extrusion operations and may restrict the range of achievable extrusion profiles. The hollow shaft design may also limit the complexity of die geometries that can be accommodated, potentially restricting the variety of product shapes that can be produced through indirect shear assisted extrusion processes.

Direct shear assisted extrusion processes may offer advantages for commercial-scale operations, particularly in terms of the range of achievable product sizes and geometries. The direct configuration may accommodate larger extrusion profiles and more complex die geometries compared to indirect systems since the die mounting constraints associated with hollow shaft designs may be eliminated. In some cases, direct shear assisted extrusion systems may be capable of processing billets with diameters of 7 inches or greater, enabling the production of commercial-scale extruded products. The ability to process larger billets may provide economic advantages through increased production throughput and may enable the manufacture of structural components and other large-scale applications that may not be feasible with smaller indirect systems.

The implementation of rotational movement in direct shear assisted extrusion systems may introduce substantial technical challenges related to the simultaneous application of high axial forces and rotational torques. The container assembly must be capable of rotating while withstanding the substantial axial forces generated during commercial-scale extrusion operations, which may exceed 20 MN or even 35 MN for large billet sizes. The integration of rotational drive systems with high-force hydraulic or mechanical actuators may require sophisticated bearing systems, sealing arrangements, and structural designs to maintain operational reliability under these demanding conditions. The stem and plunger assemblies must be capable of transmitting both axial extrusion forces and rotational torques to the billet material, which may necessitate specialized coupling mechanisms and bearing arrangements that can accommodate the combined loading conditions while maintaining precise alignment and operational control throughout the extrusion process.

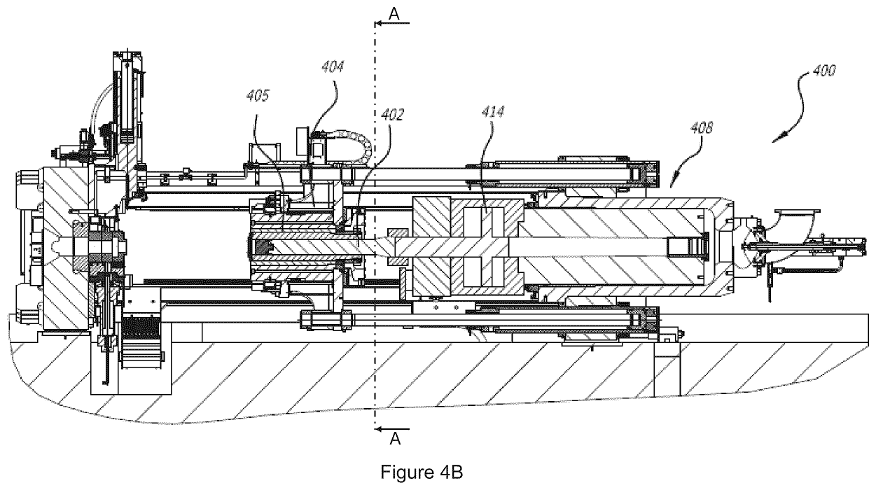

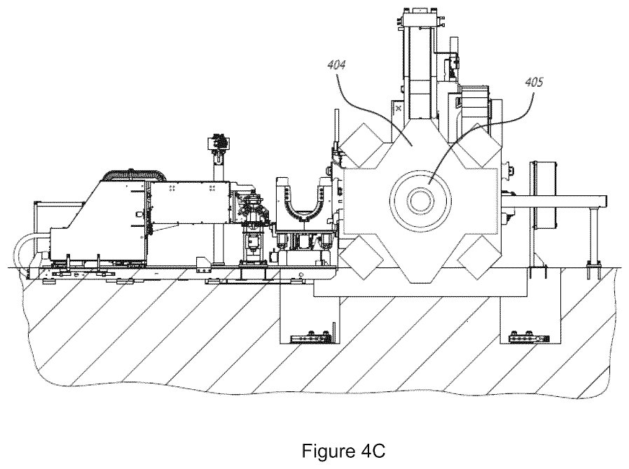

Referring to FIG. 4A, a shear assisted extrusion press 400 may be configured to enable commercial-scale direct extrusion processing through the integration of specialized assemblies and components. The shear assisted extrusion press 400 may include a container assembly 401 and a stem plunger assembly 408 that may be arranged in a coordinated configuration to facilitate the simultaneous application of axial forces and rotational shear forces during extrusion operations. The container assembly 401 and the stem plunger assembly 408 may be positioned in axial alignment to enable the transmission of forces and torques through the billet material during processing. In some cases, the shear assisted extrusion press 400 may be capable of processing billets with diameters of greater than or equal to about 7 inches, and in certain configurations, the press may accommodate billets with diameters of about 9 inches or larger, thereby enabling the production of commercial-scale extruded products that may not be achievable with smaller laboratory-scale systems.

The architectural arrangement of the shear assisted extrusion press 400 may incorporate various structural and mechanical systems that enable the handling of substantial forces and torques associated with commercial-scale extrusion operations. In some cases, the extrusion forces generated during operation may be greater than or equal to 20 MN, and for larger billet sizes or more demanding processing conditions, the forces may reach or exceed 35 MN. The stem plunger assembly 408 may be designed to generate and transmit these substantial axial forces while simultaneously accommodating the rotational components that provide shear forces to the billet material. The container assembly 401 may be configured to withstand the reaction forces generated during extrusion while maintaining the ability to rotate and impart shear forces to the contained billet material. The integration of these high-force and high-torque capabilities within a single press system may enable processing conditions that combine the benefits of conventional direct extrusion with the microstructural refinement advantages of shear assisted processing.

With reference to FIG. 4B, the internal configuration of the shear assisted extrusion press 400 may reveal the detailed arrangement of components that enable the coordinated operation of axial and rotational force systems. A stem drive 407 may be positioned with the stem plunger assembly 408 to provide the mechanical interface between hydraulic or pneumatic actuators and the rotating components of the system. An extrusion stem 402 may extend from the stem drive 407 through the container 405 to engage with the billet material during processing operations. The extrusion stem 402 may be configured to transmit both axial forces and rotational torques to the billet, enabling the simultaneous application of linear extrusion forces and rotational shear forces that characterize shear assisted extrusion processes. A container holder 404 may provide structural support and positioning for the rotating container components while accommodating the substantial forces generated during commercial-scale extrusion operations.

The cross-sectional view shown in FIG. 4B may illustrate the concentric arrangement of components that enables the coordinated operation of the various subsystems within the shear assisted extrusion press 400. A container 405 may be positioned within the container holder 404 and may be configured to receive and contain the billet material during processing operations. The container 405 may be designed to rotate relative to the container holder 404 while maintaining proper sealing and alignment with adjacent components. The rotational capability of the container 405 may enable the application of shear forces to the billet material while the container 405 remains stationary in the axial direction during the extrusion process. In some cases, the container 405 may have an internal diameter that corresponds to the billet size being processed, with diameters of 7 inches or greater being achievable for commercial-scale operations. The structural design of the container 405 may incorporate features that enable the container 405 to withstand the internal pressures and forces generated during high-force extrusion operations while maintaining dimensional stability and proper alignment with the extrusion stem 402 and die assembly components.

As further shown in FIG. 4C, the cross-sectional view of the shear assisted extrusion press 400 may reveal the detailed arrangement of bearing systems and support structures that enable the coordinated operation of rotating and stationary components under high-load conditions. A hydrostatic bearing assembly may be incorporated within the container assembly 401 to provide support and positioning for rotating components while accommodating the substantial axial and radial loads generated during extrusion operations. The hydrostatic bearing assembly may utilize pressurized fluid to maintain proper clearances and alignment between rotating and stationary components, thereby reducing friction and wear while enabling smooth rotational motion under load. The integration of the hydrostatic bearing assembly within the container assembly 401 may enable the container 405 to rotate while the container holder 404 remains stationary, facilitating the application of controlled shear forces to the billet material. The bearing systems and structural arrangements shown in these cross-sectional views may demonstrate the sophisticated mechanical design considerations that enable the shear assisted extrusion press 400 to operate reliably under the demanding conditions associated with commercial-scale direct extrusion processing.

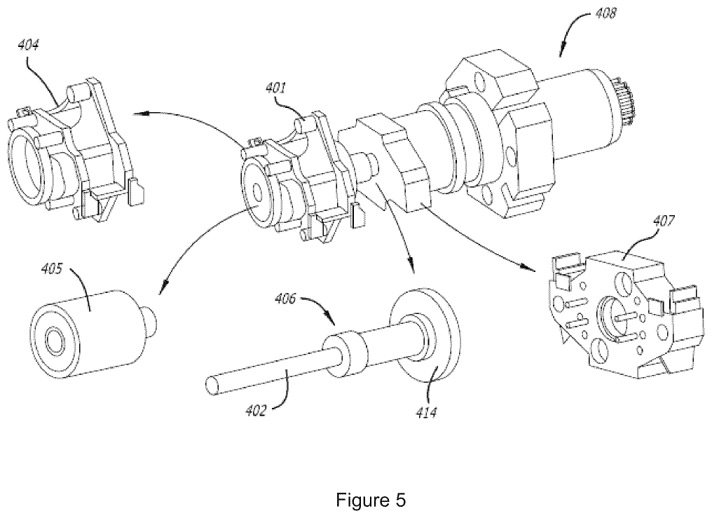

Referring to FIG. 5, the integration of multiple assemblies within the shear assisted extrusion press 400 may enable the coordinated transmission of both axial and rotational forces during commercial-scale extrusion operations. The stem plunger assembly 408, the stem drive 407, a stem assembly 406, and the container assembly 401 may be arranged in a concentric configuration that facilitates the precise alignment and mechanical coupling of force transmission systems. In some cases, the concentric arrangement of these assemblies may enable the simultaneous application of substantial axial forces and rotational torques while maintaining proper alignment and operational control throughout the extrusion process. The integration of these assemblies may provide the mechanical foundation for achieving the combined loading conditions that characterize shear assisted direct extrusion processes.

The stem assembly 406 may comprise the extrusion stem 402 and additional components that enable the transmission of both axial and rotational forces to the billet material during processing operations. In some cases, the stem assembly 406 may be configured to interface with both the stem drive 407 and the stem plunger assembly 408 to coordinate the application of forces and torques. The extrusion stem 402 within the stem assembly 406 may extend through the container assembly 401 to engage with the billet material, providing the mechanical interface through which both linear extrusion forces and rotational shear forces may be transmitted. A dummy block may be utilized between the extrusion stem 402 and the billet to facilitate the load transfer. The structural design of the stem assembly 406 may accommodate the substantial loads associated with commercial-scale extrusion while maintaining the precision and control necessary for effective shear assisted processing.

The container assembly 401 may incorporate a container body 405 that provides the containment and positioning functions for the billet material during extrusion operations. In some cases, the container body 405 may be designed to rotate relative to the container holder 404 while maintaining proper sealing and alignment with adjacent components. The rotational capability of the container body 405 may enable the application of controlled shear forces to the contained billet material while the container body 405 remains stationary in the axial direction during the extrusion process. The integration of the container body 405 within the container assembly 401 may provide the structural containment necessary for high-pressure extrusion operations while accommodating the rotational motion that distinguishes shear assisted processes from conventional extrusion methods.

The concentric alignment of the stem plunger assembly 408, the stem drive 407, the stem assembly 406, and the container assembly 401 may facilitate the coordinated operation of multiple force transmission systems within a single integrated apparatus. In some cases, the stem plunger assembly 408 may provide the primary axial force generation capability, while the stem drive 407 may coordinate the rotational components that impart shear forces to the billet material. In some cases, the stem drive 407 also provides axial forces to drive the axial movement. The stem assembly 406 may serve as the mechanical interface that combines these axial and rotational force components for transmission to the billet material through the extrusion stem 402. The container assembly 401 may provide both the containment function for the billet material and the rotational shear force application through the movement of the container body 405. The precise alignment and integration of these assemblies may enable the apparatus to achieve the complex loading conditions necessary for effective shear assisted direct extrusion while maintaining operational reliability under the demanding conditions associated with commercial-scale processing.

The mechanical coupling between the stem drive 407 and the stem assembly 406 may enable the coordinated application of rotational forces while accommodating the substantial axial loads generated by the stem plunger assembly 408. In some cases, the stem drive 407 may incorporate rotational drive systems that impart torque to the stem assembly 406, which may then transmit this rotational motion to the extrusion stem 402 and ultimately to the billet material. The integration of rotational drive capabilities within the stem drive 407 may enable precise control over the magnitude and timing of shear force application during the extrusion process. The structural design of the interface between the stem drive 407 and the stem assembly 406 may accommodate the simultaneous transmission of both axial forces from the stem plunger assembly 408 and rotational torques from the rotational drive systems, enabling the combined loading conditions that characterize shear assisted extrusion processes.

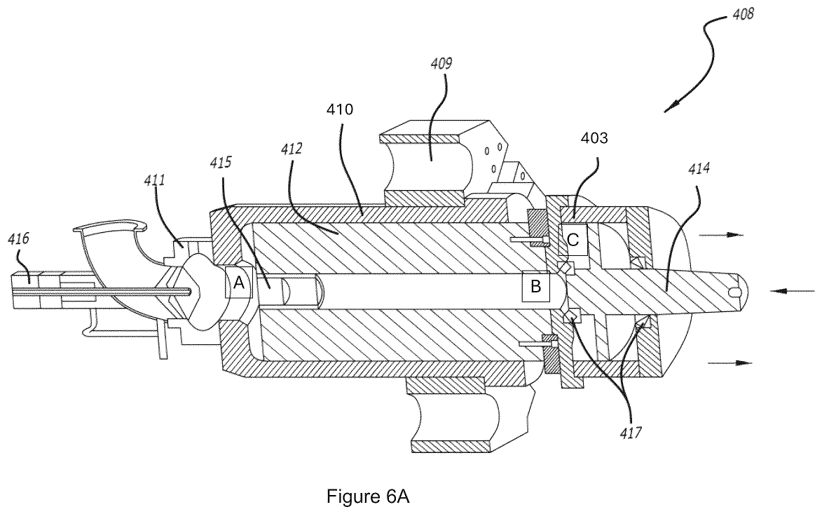

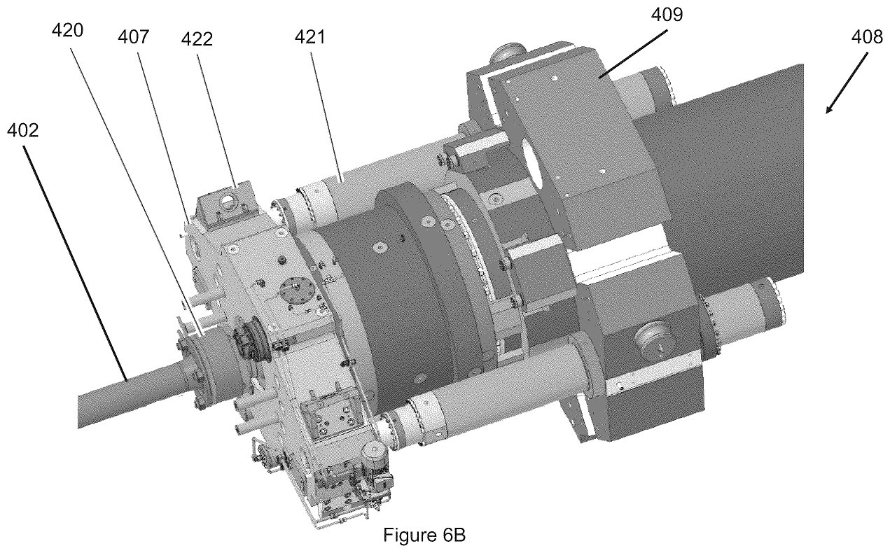

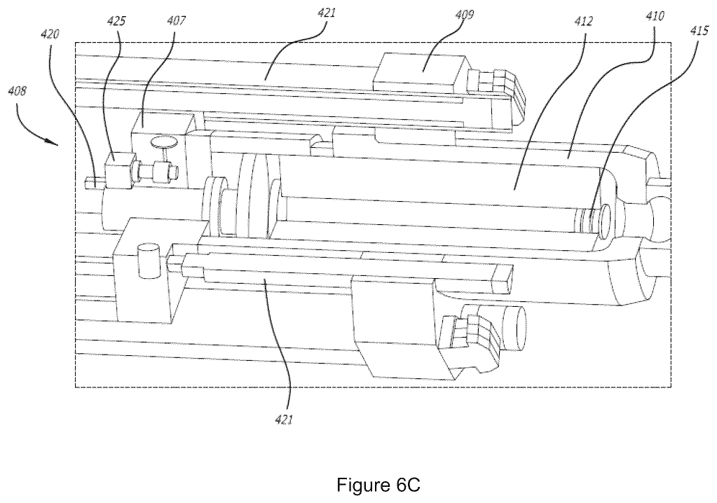

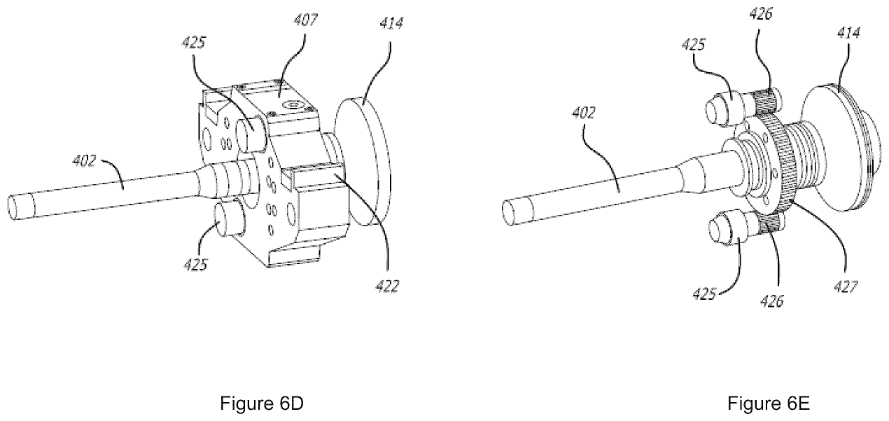

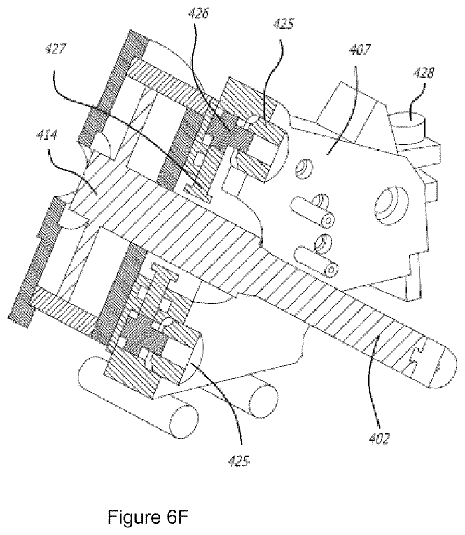

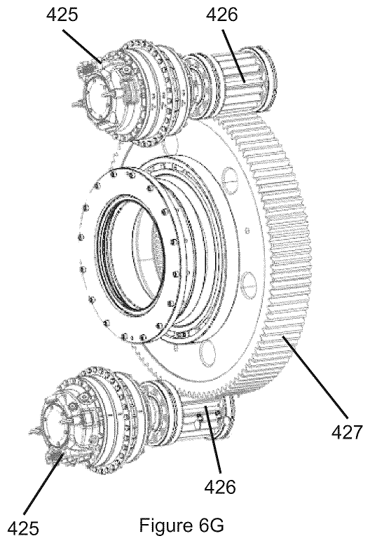

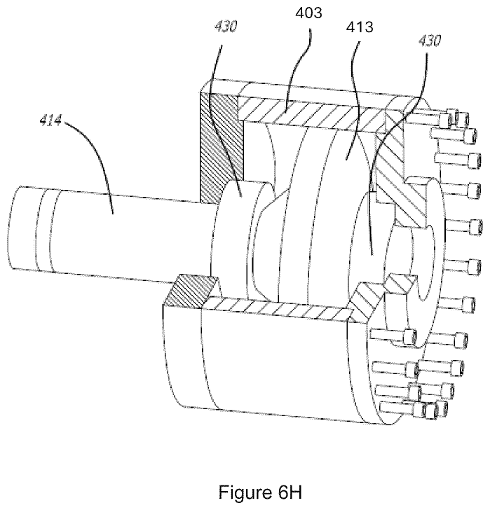

Referring to FIG. 6A, the stem plunger assembly 408 may incorporate various hydraulic and mechanical components that enable the coordinated application of substantial axial forces while accommodating rotational drive capabilities during commercial-scale extrusion operations. A main cylinder 410 may be positioned within the stem plunger assembly 408 and may be connected to a cylinder crosshead 409 through a mechanical coupling arrangement that facilitates force transmission and structural alignment. The main cylinder 410 may provide the primary containment and guidance functions for hydraulic actuator components, while the cylinder crosshead 409 may serve as a structural interface that coordinates the positioning and movement of multiple system components. A prefill valve 411 may be integrated within the hydraulic system to control the flow of hydraulic fluid into designated pressure chambers, thereby enabling the initiation and control of axial force generation during extrusion operations. The prefill valve 411 may facilitate the controlled introduction of hydraulic fluid into area A, which may enable the coordinated movement of downstream hydraulic components and the generation of the substantial forces associated with commercial-scale direct extrusion processing.

The hydraulic actuation system within the stem plunger assembly 408 may incorporate a main piston 412 that serves as the primary force transmission element between the hydraulic fluid system and the mechanical components that interface with the billet material. In some cases, the main piston 412 may be configured with a hollow center section that may contain lubricating fluid or other specialized fluids that facilitate the operation of bearing systems and mechanical interfaces under high-load conditions. The main piston 412 may be positioned to respond to hydraulic pressure changes within area A, and as hydraulic pressure increases within this region, the main piston 412 may move forward to initiate the extrusion process. A hydraulic bearing 403 may be positioned adjacent to the main piston 412 to accommodate the substantial axial loads generated during extrusion operations while enabling controlled movement and positioning of force transmission components. The hydraulic bearing 403 may facilitate the transfer of axial forces from the hydraulic system to the mechanical components that engage with the billet material, thereby enabling the application of the substantial forces that may be greater than or equal to 20 MN or even 35 MN for commercial-scale operations.

With continued reference to FIG. 6A, a rotary piston 414 may be integrated within the stem plunger assembly 408 to provide the mechanical interface between the hydraulic force generation system and the rotational drive components that impart shear forces to the billet material. The rotary piston 414 may be configured to rotate while simultaneously transmitting the substantial axial forces generated by the main piston 412, thereby enabling the combined loading conditions that characterize shear assisted direct extrusion processes. In some cases, the rotary piston 414 may be mechanically coupled to the extrusion stem 402 such that both axial forces and rotational torques may be transmitted through this interface to the billet material during processing operations. The rotary piston 414 may rotate during extrusion operations while the main piston 412 and the main cylinder 410 remain stationary, thereby enabling the selective application of rotational shear forces without interfering with the hydraulic force generation capabilities of the system. A pressure piston 415 may be positioned within the hydraulic system to maintain pressure balance between multiple pressure regions, including areas B and C, such that equilibrium conditions may be established with area D and the forces acting on the rotary piston 414.

The hydraulic system within the stem plunger assembly 408 may incorporate pressure balance mechanisms that enable the coordinated operation of multiple hydraulic chambers while maintaining force equilibrium across various system components. As hydraulic pressure increases within area A due to the operation of the prefill valve 411, the pressure piston 415 may be displaced forward, and corresponding pressure increases may be established within areas B and C to maintain force balance conditions. In some cases, the pressure of lubricating fluid contained within the hollow center section of the main piston 412 may reach equilibrium with the pressure of the hydraulic fluid within the primary hydraulic chambers, thereby ensuring that the stem assembly 406 may be displaced axially during extrusion operations while maintaining proper force balance across the rotary piston 414 and area D. This pressure equilibrium mechanism may enable the hydraulic bearing 403 to operate effectively under the substantial loads associated with commercial-scale extrusion while providing the lubrication and support functions that facilitate smooth rotational motion of the rotary piston 414 and associated components.

As further shown in FIG. 6A, the positioning and alignment of the rotary piston 414 within the stem plunger assembly 408 may be maintained through the integration of specialized bearing systems that accommodate both axial and rotational loading conditions. A tapered roller bearing 417 may be positioned to provide radial support and positioning for the rotary piston 414 while enabling smooth rotational motion under the substantial loads generated during extrusion operations. In some cases, multiple roller bearings 417 may be incorporated within the bearing system to distribute loads and provide enhanced positioning stability for the rotary piston 414 during both axial and rotational motion. A cable encoder 416 may be connected to the pressure piston 415 to provide position monitoring and feedback capabilities that enable precise control over the hydraulic system operation and the positioning of various system components during extrusion operations. The cable encoder 416 may facilitate the monitoring of pressure piston 415 position, thereby enabling operators or automated control systems to track the progression of the extrusion process and maintain proper coordination between the hydraulic force generation system and the rotational drive components that provide shear forces to the billet material.

Referring to FIG. 6B, the stem plunger assembly 408 may incorporate additional mechanical systems that facilitate the integration of rotational drive capabilities with the hydraulic force generation components described in relation to FIG. 6A. A stem fastening system 420 may be positioned within the stem plunger assembly 408 to provide secure mechanical coupling between the rotational drive components and the extrusion stem 402 that interfaces directly with the billet material. In some cases, the stem fastening system 420 may enable the transmission of both axial forces generated by the hydraulic system and rotational torques generated by rotational drive components, thereby facilitating the combined loading conditions that characterize shear assisted direct extrusion processes. The stem drive 407 may be mechanically coupled to the stem fastening system 420 to coordinate the application of rotational forces while accommodating the substantial axial loads generated by the main piston 412 and associated hydraulic components. Side cylinders 421 may be positioned laterally relative to the primary axis of the stem plunger assembly 408 and may be connected to the stem drive 407 through mechanical linkages that enable coordinated movement and force application during extrusion operations. The side cylinders 421 can provide additional axial extrusion force.

The mechanical arrangement shown in FIG. 6B may demonstrate the integration of multiple force transmission systems within the stem plunger assembly 408 that enable both hydraulic force generation and rotational drive capabilities. In some cases, the side cylinders 421 may provide supplementary force generation or positioning control functions that complement the primary hydraulic force generation capabilities of the main cylinder 410 and the main piston 412. Holders 422 may be positioned on the stem drive 407 to facilitate mechanical integration with other components of the shear assisted extrusion press 400, thereby enabling the coordinated operation of multiple subsystems during commercial-scale extrusion operations. The holders 422 may provide mounting points or mechanical interfaces that enable the stem drive 407 to be integrated with structural support systems, control systems, or other mechanical assemblies that contribute to the overall operation of the extrusion apparatus. The positioning and configuration of the stem fastening system 420, the side cylinders 421, and the holders 422 may facilitate the precise alignment and mechanical coupling of force transmission systems while accommodating the substantial loads and complex motion patterns associated with shear assisted direct extrusion processing.

With reference to FIG. 6C, the internal configuration of the stem plunger assembly 408 may reveal the detailed arrangement of rotational drive components that enable the application of controlled shear forces during extrusion operations. A stem drive assembly 429 may be integrated within the stem plunger assembly 408 to coordinate the operation of rotational drive systems with the hydraulic force generation components described in relation to FIGS. 6A and 6B. The stem drive assembly 429 may incorporate mechanical interfaces that enable the transmission of rotational torques from drive motors to the rotary piston 414 and the extrusion stem 402, thereby facilitating the application of shear forces to the billet material during processing operations. A gear wheel 427 may be positioned within the stem drive assembly 429 to provide mechanical advantage and torque multiplication for the rotational drive system, enabling the generation of substantial rotational forces that may complement the axial forces generated by the hydraulic system components.

The rotational drive capabilities of the stem plunger assembly 408 may be provided through the integration of hydraulic rotary motors 425 that interface with the gear wheel 427 and other mechanical transmission components. In some cases, the hydraulic rotary motors 425 may be capable of generating substantial torques that may be transmitted through the gear wheel 427 to the rotary piston 414 and ultimately to the extrusion stem 402 and the billet material. The hydraulic rotary motors 425 may operate independently of the primary hydraulic force generation system, thereby enabling independent control over the magnitude and timing of rotational shear force application during the extrusion process. The integration of the hydraulic rotary motors 425 with the gear wheel 427 may enable the generation of rotational torques that may reach or exceed 60,000 Nm for stem rotation applications, providing the substantial shear forces that may be associated with commercial-scale shear assisted direct extrusion processing.

The integration of these components within the stem plunger assembly 408 may enable precise control over both axial forces and rotational motion during extrusion operations. The hydraulic systems may maintain appropriate pressure balances and lubrication conditions while accommodating the substantial loads associated with commercial-scale extrusion processes. The mechanical coupling between stationary and rotating components may facilitate the coordinated application of linear and rotational forces through the extrusion stem 402 to the billet material during processing operations.

Referring to FIGS. 6D and 6E, the stem drive 407 may incorporate rotational drive systems that enable the coordinated application of torque to the extrusion stem 402 during shear assisted extrusion operations. The stem drive 407 may be positioned to interface with the stem assembly 406 and may provide the mechanical coupling between rotational drive components and the extrusion stem 402 that extends through the container assembly 401. In some cases, the stem drive 407 may facilitate the transmission of rotational forces while accommodating the substantial axial loads generated by the hydraulic force generation systems described in relation to the stem plunger assembly 408. The integration of rotational drive capabilities within the stem drive 407 may enable precise control over the application of shear forces to the billet material during commercial-scale extrusion operations. The container body 405 may be positioned to receive the extrusion stem 402 and may rotate in coordination with the rotational motion imparted by the stem drive 407 to facilitate the application of combined axial and rotational forces during processing operations.

With reference to FIG. 6F, the rotational drive system within the stem drive 407 may incorporate hydraulic rotary motors 425 that provide the torque generation capabilities for shear assisted extrusion operations. The hydraulic rotary motors 425 may be configured to generate substantial rotational forces that may be transmitted through mechanical coupling systems to the rotary piston 414 and the extrusion stem 402. In some cases, the hydraulic rotary motors 425 may operate independently of the primary hydraulic force generation systems, thereby enabling separate control over the magnitude and timing of rotational shear force application during the extrusion process. The hydraulic rotary motors 425 may be positioned to interface with mechanical transmission components that multiply and direct the generated torque to the appropriate system elements. A lubricating pump 428 may be integrated within the rotational drive system to provide continuous lubrication to bearing points and mechanical interfaces that operate under the substantial loads associated with commercial-scale extrusion processing.

The mechanical transmission system within the stem drive 407 may incorporate pinion shafts 426 that serve as intermediate torque transmission elements between the hydraulic rotary motors 425 and the central gear wheel 427. In some cases, two hydraulic rotary motors 425 may be arranged to drive two corresponding pinion shafts 426, thereby providing distributed torque input to the gear wheel 427 and enabling enhanced torque capacity and operational reliability. The pinion shafts 426 may be configured to mesh with the gear wheel 427 and may transmit the rotational forces generated by the hydraulic rotary motors 425 through mechanical engagement with the gear teeth or other coupling features of the gear wheel 427. The gear wheel 427 may serve as a central torque collection and transmission element that receives rotational input from multiple pinion shafts 426 and directs the combined torque to the rotary piston 414 and the extrusion stem 402 through spline gearing or other mechanical coupling arrangements. The integration of multiple pinion shafts 426 with the gear wheel 427 may enable the rotational drive system to achieve torque transmission capabilities that may reach a maximum torque of about 60,000 Nm for stem rotation applications.

As further shown in FIG. 6F, the torque transmission pathway within the stem drive 407 may enable the coordinated transfer of rotational forces from the hydraulic rotary motors 425 through the mechanical transmission components to the extrusion stem 402 and ultimately to the billet material during processing operations. The rotary pulse and torque generated by the hydraulic rotary motors 425 may be transmitted to the rotary piston 414 and the extrusion stem 402 through the spline gearing connection with the gear wheel 427, thereby enabling the application of controlled shear forces to the contained billet material. In some cases, the spline gearing arrangement may provide positive mechanical coupling between the gear wheel 427 and the rotary piston 414, ensuring reliable torque transmission under the varying load conditions that may occur during commercial-scale extrusion operations. The lubricating pump 428 may provide continuous lubrication to all bearing points within the rotational drive system, including the interfaces between the pinion shafts 426 and the gear wheel 427, the spline gearing connections, and the bearing systems that support the rotary piston 414 during rotational motion under load.

With reference to FIG. 6G, the arrangement of hydraulic rotary piston motors 425 relative to the gear wheel 427 may demonstrate the distributed torque input configuration that enables enhanced torque capacity and operational reliability during commercial-scale extrusion operations. The hydraulic rotary piston motors 425 may be positioned at approximately 180-degree intervals around the gear wheel 427, thereby providing balanced torque input and reducing the mechanical stresses that may develop within the gear wheel 427 during high-torque operation. In some cases, the hydraulic rotary piston motors 425 may be mounted to structural supports that maintain proper alignment and positioning relative to the gear wheel 427 while accommodating the reaction forces generated during torque transmission. The pinion shafts 426 may extend from each hydraulic rotary piston motor 425 to engage with the gear wheel 427 through mechanical coupling arrangements that enable efficient torque transfer while accommodating the rotational motion and load variations that may occur during extrusion processing. The distributed arrangement of the hydraulic rotary piston motors 425 and the pinion shafts 426 may enable the rotational drive system to operate smoothly under the substantial torque requirements associated with commercial-scale shear assisted direct extrusion while maintaining proper mechanical alignment and operational control throughout the processing cycle.

Referring to FIG. 6H, a combined bearing system may be incorporated within the stem assembly 406 to provide comprehensive support and positioning capabilities for rotating components that operate under the substantial loads associated with commercial-scale shear assisted direct extrusion processing. The combined bearing system may integrate multiple bearing technologies to accommodate both axial and radial loading conditions while maintaining proper separation between rotating and stationary components during operation. In some cases, the bearing system may be configured to handle the complex loading conditions that result from the simultaneous application of substantial axial forces and rotational torques during extrusion operations. The integration of multiple bearing types within a single system may enable enhanced load distribution and operational reliability under the demanding conditions that may be encountered during commercial-scale processing operations.

The rotary piston 414 may be supported within the combined bearing system through the integration of roller bearings 430 that provide radial positioning and support functions during rotational motion under load. In some cases, the roller bearings 430 may be arranged to maintain the rotary piston 414 in proper axial and radial alignment while accommodating the rotational motion that occurs during shear assisted extrusion operations. The roller bearings 430 may be configured to distribute the radial loads that develop during operation across multiple contact points, thereby reducing contact stresses and enhancing the operational life of the bearing system. The positioning of the roller bearings 430 relative to the rotary piston 414 may enable smooth rotational motion while providing the structural support necessary to maintain proper alignment under the substantial forces that may be generated during commercial-scale extrusion processing.

The hydraulic bearing 403 (also referred to as thrust bearing) may be positioned within the combined bearing system to accommodate the substantial axial loads that may be transmitted through the rotary piston 414 during extrusion operations. In some cases, the hydraulic bearing 403 may be configured to handle axial forces that may be greater than or equal to 20 MN or even 35 MN for large-scale commercial applications. The hydraulic bearing 403 may provide a load-bearing interface between the hydraulic force generation components and the rotating elements of the system, thereby enabling the transmission of axial forces while accommodating the rotational motion of the rotary piston 414. The integration of the hydraulic bearing 403 within the combined bearing system may facilitate the coordinated operation of both axial force transmission and rotational motion capabilities within a single mechanical interface.

The hydraulic bearing 403 may be incorporated within the combined bearing system to provide support and positioning functions while facilitating the maintenance of proper clearances between rotating and stationary components. In some cases, the hydraulic bearing 403 may utilize pressurized lubricating fluid to create a controlled separation between adjacent surfaces, thereby reducing friction and wear while enabling smooth rotational motion under load conditions. The hydraulic bearing 403 may operate in coordination with the roller bearings 430 to provide comprehensive support for the rotary piston 414 during both axial and rotational loading conditions. The pressurized fluid within the hydraulic bearing 403 may maintain consistent clearances and lubrication conditions even as the loading conditions vary during the extrusion process, thereby contributing to the operational reliability and longevity of the combined bearing system.

The arrangement of the roller bearings 430 and the hydraulic bearing 403 within the combined bearing system may enable the effective separation of rotating and stationary components while accommodating the complex loading conditions associated with shear assisted direct extrusion. The roller bearings 430 may remain stationary and may provide sealing functions that separate the rotary piston 414 from lubricating fluids and other system components. In some cases, the rotating parts, including the rotary piston 414 and the hydraulic bearing 403, may operate independently of the stationary parts, including the roller bearings 430, thereby enabling controlled rotational motion while maintaining proper force transmission capabilities. The coordinated operation of these bearing components may facilitate the simultaneous handling of substantial axial loads and rotational torques while maintaining the precision and control necessary for effective shear assisted extrusion processing at commercial scales.

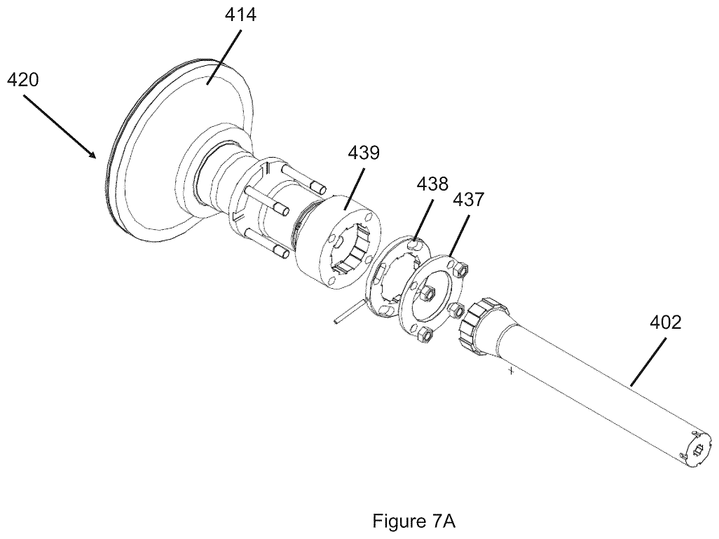

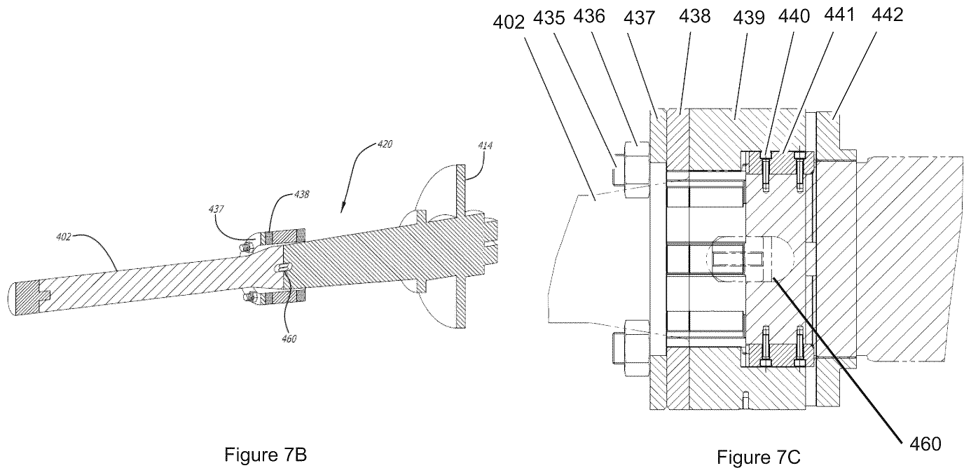

Referring to FIG. 7A, a stem fastening system 420 may be incorporated within the shear assisted extrusion press 400 to provide secure mechanical coupling between rotational drive components and the extrusion stem 402 during commercial-scale extrusion operations. The stem fastening system 420 may enable the coordinated transmission of both substantial axial forces generated by hydraulic systems and rotational torques generated by the gear wheel 427 and associated drive components. In some cases, the stem fastening system 420 may facilitate the reliable transfer of rotational forces while accommodating the complex loading conditions that develop during shear assisted direct extrusion processing. The mechanical arrangement of the stem fastening system 420 may provide the structural interface that enables the extrusion stem 402 to receive both linear extrusion forces and rotational shear forces for transmission to the billet material during processing operations. A stem lock 460 may be integrated within the stem fastening system 420 to provide controlled engagement and disengagement capabilities that facilitate maintenance operations and component replacement procedures while maintaining operational reliability under the demanding conditions associated with commercial-scale processing.

With reference to FIGS. 7B and 7C, the stem fastening system 420 may incorporate multiple mechanical components that enable the secure attachment and controlled positioning of the extrusion stem 402 relative to the rotary piston 414 and associated drive components. A front plate 437 may be positioned within the stem fastening system 420 to provide the primary load-bearing interface that receives and distributes the substantial axial forces generated during extrusion operations. In some cases, the front plate 437 may serve as a force distribution element that transfers extrusion forces from the main piston 412 across a wide contact area, thereby reducing contact stresses and enhancing the structural integrity of the force transmission pathway. The front plate 437 may be configured to accommodate the substantial forces that may be greater than or equal to 20 MN or even 35 MN during commercial-scale operations while maintaining proper alignment and mechanical coupling with adjacent system components. A bayonet ring 438 may be mechanically coupled to the front plate 437 through a fastening arrangement that enables the coordinated transmission of both axial and rotational forces during extrusion processing.

The mechanical coupling between the front plate 437 and the bayonet ring 438 may be achieved through the integration of fastening pins 435 and hexagon nuts 436 that provide secure attachment while enabling controlled assembly and disassembly procedures. In some cases, the fastening pins 435 may extend through corresponding openings in the front plate 437 and the bayonet ring 438 to establish positive mechanical engagement between these components. The hexagon nuts 436 may be threaded onto the fastening pins 435 to provide adjustable clamping force that secures the mechanical connection while enabling precise control over the assembly preload conditions. The arrangement of the fastening pins 435 and the hexagon nuts 436 may facilitate the reliable transmission of both axial forces and rotational torques through the interface between the front plate 437 and the bayonet ring 438 during extrusion operations. The bayonet ring 438 may incorporate features that enable the bayonet ring 438 to interface with the extrusion stem 402 through a bayonet-style coupling mechanism that provides secure attachment while enabling controlled engagement and disengagement procedures.

As further shown in FIGS. 7B and 7C, the stem fastening system 420 may incorporate a base plate 439 that provides the structural foundation for the mechanical coupling between the stem fastening system 420 and the rotary piston 414. The base plate 439 may be positioned to receive and distribute the combined axial and rotational forces that are transmitted through the bayonet ring 438 during extrusion operations. In some cases, the base plate 439 may serve as an intermediate structural element that facilitates the mechanical interface between the stem fastening components and the rotational drive systems that provide torque input to the extrusion stem 402. The bayonet ring 438 may be mechanically attached to the base plate 439 through a fastening arrangement that maintains proper alignment and force transmission capabilities while accommodating the rotational motion that occurs during shear assisted extrusion processing. Socket head bolts 440 may be incorporated within the fastening arrangement to provide secure mechanical coupling between the base plate 439 and the rotary piston 414, thereby enabling the transmission of rotational torques from the gear wheel 427 and associated drive components to the extrusion stem 402.

The mechanical interface between the base plate 439 and the rotary piston 414 may incorporate fitting keys 441 that provide positive rotational coupling while maintaining proper axial alignment during operation. In some cases, the fitting keys 441 may be positioned within corresponding keyways or grooves in the base plate 439 and the rotary piston 414 to prevent relative rotational motion between these components while enabling the coordinated transmission of torque from the rotational drive system to the extrusion stem 402. The socket head bolts 440 may extend through the base plate 439 and may be threaded into corresponding openings in the rotary piston 414 to establish secure axial coupling while accommodating the fitting keys 441 that provide rotational constraint. A retaining ring 442 may be attached to the base plate 439 to provide additional structural support and positioning functions that enhance the mechanical stability of the stem fastening system 420 during operation under substantial loads. The retaining ring 442 may serve as a backup retention mechanism that maintains proper component positioning even under the varying load conditions that may occur during commercial-scale extrusion processing.

The stem fastening system 420 may incorporate locking and unlocking mechanisms that enable controlled engagement and disengagement of the extrusion stem 402 during maintenance operations and component replacement procedures. The stem lock 460 may be configured to operate between unlocked and locked positions that correspond to different operational states of the stem fastening system 420. In the unlocked position, the bayonet ring 438 may be positioned to allow relative movement between the extrusion stem 402 and the stem fastening system 420, thereby enabling the insertion, removal, or repositioning of the extrusion stem 402 during setup or maintenance procedures. The fastening pins 435 and the hexagon nuts 436 may be positioned to accommodate the unlocked configuration while maintaining proper alignment and positioning of the bayonet ring 438 relative to adjacent components. In some cases, the unlocked position may enable operators to perform maintenance operations or component replacements without requiring complete disassembly of the stem fastening system 420 or associated drive components.

The locked position may correspond to the operational configuration of the stem fastening system 420 during extrusion processing, where the bayonet ring 438 may be positioned to provide secure mechanical coupling between the extrusion stem 402 and the rotational drive components. In the locked position, the fastening pins 435 and the hexagon nuts 436 may be arranged to provide maximum clamping force and mechanical constraint, thereby ensuring reliable force transmission during the substantial loading conditions associated with commercial-scale extrusion operations. The transition between the unlocked and locked positions may be achieved through controlled rotation or axial movement of the bayonet ring 438 relative to the extrusion stem 402, with the fastening pins 435 and the hexagon nuts 436 providing the mechanical constraint that maintains the desired position during operation. The bayonet-style coupling mechanism may enable rapid and reliable engagement and disengagement procedures while providing the mechanical strength and reliability that may be associated with commercial-scale shear assisted direct extrusion processing applications.

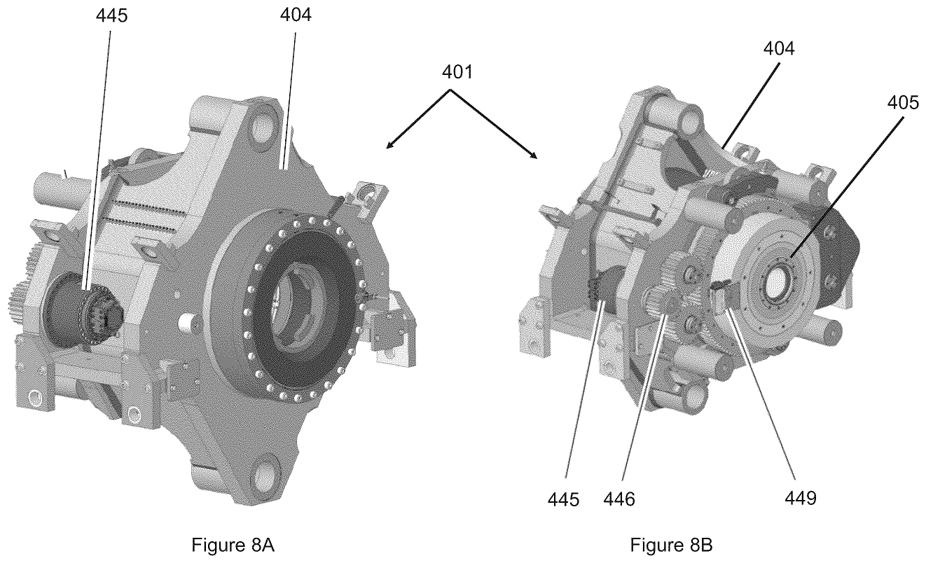

Referring to FIGS. 8A and 8B, the container assembly 401 may incorporate various structural and mechanical systems that enable the coordinated application of rotational forces while maintaining the structural integrity and alignment necessary for commercial-scale shear assisted direct extrusion operations. The container assembly 401 may include the container holder 404 and the container body 405, which may be arranged in a coordinated configuration that facilitates both the containment of billet material and the application of controlled rotational shear forces during processing operations. In some cases, the container assembly 401 may be configured to accommodate billets with lengths of about 400 mm to about 1300 mm, thereby enabling the processing of various billet sizes that may be associated with commercial-scale manufacturing applications. The structural arrangement of the container assembly 401 may provide the mechanical foundation for withstanding the substantial forces and torques that may be generated during direct extrusion processing while maintaining proper alignment and operational control throughout the extrusion cycle.

The container holder 404 may serve as the primary structural support element within the container assembly 401 and may incorporate various mechanical systems that enable the controlled rotation of the container body 405 during extrusion operations. A container housing may be integrated within the container holder 404 to provide structural containment and positioning functions for the container body 405 and associated mechanical components. In some cases, the container housing may be configured to accommodate the rotational motion of the container body 405 while maintaining proper alignment and structural support under the substantial loads that may be generated during commercial-scale extrusion processing. The container housing may incorporate features that facilitate the integration of rotational drive systems, bearing assemblies, and sealing components that enable the coordinated operation of the container assembly 401 during shear assisted direct extrusion operations. The structural design of the container housing may provide the mechanical framework that supports the various subsystems within the container assembly 401 while accommodating the complex motion patterns and loading conditions associated with the simultaneous application of axial and rotational forces.

With continued reference to FIGS. 8A and 8B, the container assembly 401 may incorporate a container support system that provides enhanced structural stability and load distribution capabilities during high-force extrusion operations. A container support may be positioned within the container holder 404 to distribute the substantial reaction forces that may be generated during the extrusion process across multiple structural elements, thereby reducing localized stresses and enhancing the operational reliability of the container assembly 401. In some cases, the container support may be configured to accommodate the rotational motion of the container body 405 while providing the structural reinforcement that may be associated with processing forces that may be greater than or equal to 20 MN or even 35 MN for large-scale commercial applications. The container support may incorporate features that facilitate the transfer of axial and radial loads from the container body 405 to the container holder 404 and ultimately to the structural framework of the shear assisted extrusion press 400. The integration of the container support within the container assembly 401 may enable the apparatus to maintain proper alignment and dimensional stability even under the varying load conditions that may occur during the processing of different billet materials and geometries.

The bearing systems within the container assembly 401 may provide the mechanical interfaces that enable smooth rotational motion while accommodating the substantial loads associated with commercial-scale direct extrusion processing. A container bearing may be incorporated within the container holder 404 to facilitate the rotational motion of the container body 405 while maintaining proper radial and axial positioning during operation. In some cases, the container bearing may be configured to distribute the radial loads that develop during rotation across multiple contact surfaces, thereby reducing contact stresses and enhancing the operational life of the bearing system. The container bearing may operate in coordination with other bearing components within the container assembly 401 to provide comprehensive support for the rotating elements while accommodating the complex loading conditions that result from the simultaneous application of axial extrusion forces and rotational shear forces. A stem bearing system may be positioned within the container assembly 401 to provide additional support and alignment functions for the extrusion stem 402 as the extrusion stem 402 extends through the container body 405 during processing operations. The stem bearing system may facilitate the coordinated motion of the extrusion stem 402 and the container body 405 while maintaining proper clearances and alignment under the substantial loads that may be encountered during commercial-scale extrusion processing.

As further shown in FIGS. 8A and 8B, the container assembly 401 may incorporate sealing systems that prevent material leakage and maintain proper containment during the high-pressure, high-temperature conditions associated with shear assisted direct extrusion processing. A container seal may be positioned at the interface between the container body 405 and adjacent components to prevent the escape of billet material or lubricating fluids during extrusion operations. In some cases, the container seal may be configured to accommodate the rotational motion of the container body 405 while maintaining effective sealing performance under the substantial pressures that may be generated within the container body 405 during material deformation and flow. The container seal may incorporate features that enable the container seal to maintain sealing effectiveness even as the container body 405 rotates and as the internal pressure conditions vary during the extrusion process. The sealing system may operate in coordination with the bearing systems and structural support elements within the container assembly 401 to provide comprehensive containment and positioning functions that enable reliable operation under the demanding conditions associated with commercial-scale processing applications.

The mounting and positioning systems within the container assembly 401 may provide the mechanical interfaces that enable precise alignment and controlled positioning of the container body 405 relative to the extrusion stem 402 and associated die components during processing operations. A container mount may be incorporated within the container holder 404 to provide secure attachment and positioning functions for the container body 405 while accommodating the rotational motion that occurs during shear assisted extrusion processing. In some cases, the container mount may include centering devices and swivel pinions that facilitate the center alignment of the container body 405 relative to the extrusion stem 402 and other system components. The centering devices may provide radial positioning control that maintains proper alignment between the container body 405 and the extrusion stem 402 even as these components undergo rotational motion during operation. The swivel pinions may enable controlled rotational positioning of the container body 405 while maintaining the structural coupling that facilitates force transmission and alignment control during extrusion operations. The integration of the container mount with the centering devices and swivel pinions may enable the container assembly 401 to maintain precise positioning and alignment throughout the extrusion cycle while accommodating the complex motion patterns associated with shear assisted direct extrusion processing.

The structural design of the container body 405 may incorporate features that enable the container body 405 to withstand the substantial internal pressures and mechanical stresses that may be generated during commercial-scale direct extrusion processing. In some cases, the container body 405 may be constructed as a multi-layer container structure that includes three layers or more than three layers to provide enhanced structural strength and pressure resistance capabilities. The multi-layer construction may enable the container body 405 to distribute internal pressures across multiple structural elements, thereby reducing the stress concentrations that might otherwise develop in single-layer container designs. The individual layers within the multi-layer container structure may be configured to work in coordination to provide comprehensive structural support while accommodating the thermal expansion and mechanical deformation that may occur during high-temperature, high-pressure extrusion operations. The container body 405 may be fabricated from tool steel materials that provide the strength and durability characteristics associated with commercial-scale extrusion processing applications. In some cases, the container body 405 may be constructed from hot-work tool steel, H13 steel, or H11 steel, which may provide enhanced resistance to the thermal and mechanical stresses that may be encountered during the processing of various metallic materials at elevated temperatures and pressures.

The dimensional characteristics of the container body 405 may be configured to accommodate various billet sizes and geometries that may be associated with commercial-scale manufacturing applications. In some cases, the container body 405 may have a length that may be greater than or equal to the length of the billet material being processed, thereby ensuring complete containment and support for the billet throughout the extrusion operation. The container body 405 may be designed to accommodate billets with lengths ranging from about 400 mm to about 1300 mm, enabling the processing of various billet sizes that may be associated with different product applications and manufacturing requirements. The internal diameter of the container body 405 may correspond to the cross-sectional dimensions of the billet material, with the container body 405 being capable of accommodating billets with diameters of 7 inches or greater for commercial-scale operations. The dimensional flexibility of the container body 405 may enable the container assembly 401 to process various billet configurations while maintaining proper containment and force transmission capabilities throughout the extrusion process.

The rotational drive system within the container holder 404 may incorporate radial piston motors 445 that provide the primary torque generation capability for rotating the container body 405 during shear assisted extrusion operations. In some cases, the radial piston motors 445 may be configured to generate substantial rotational forces that enable the application of controlled shear forces to the billet material contained within the container body 405. The radial piston motors 445 may operate through hydraulic actuation systems that provide precise control over the rotational speed and torque output during various phases of the extrusion process. The positioning of the radial piston motors 445 within the container holder 404 may enable direct mechanical coupling with the container body 405 while maintaining proper structural support and alignment under the substantial loads associated with commercial-scale processing operations. The radial piston motors 445 may be capable of transmitting a maximum torque of about 120,000 Nm for container rotation applications, thereby providing the substantial rotational forces that may be associated with processing large billets and achieving the severe deformation conditions that characterize shear assisted direct extrusion processes.

With continued reference to FIGS. 8A and 8B, the mechanical transmission system within the container holder 404 may incorporate a gear unit 446 that serves as an intermediate torque transmission and multiplication element between the radial piston motors 445 and the container body 405. The gear unit 446 may be positioned to receive rotational input from the radial piston motor 445 and may provide mechanical advantage through gear ratio arrangements that enable enhanced torque output and controlled rotational speed characteristics. In some cases, the gear unit 446 may incorporate multiple gear stages or reduction ratios that enable the optimization of torque and speed characteristics for different processing conditions and billet materials. The mechanical coupling between the radial piston motors 445 and the gear unit 446 may provide reliable torque transmission while accommodating the varying load conditions that may occur during the processing of different billet sizes and material compositions. The gear unit 446 may be configured to interface directly with the container body 405 through mechanical coupling arrangements that enable the coordinated rotation of the container body 405 and the contained billet material during shear assisted extrusion operations.

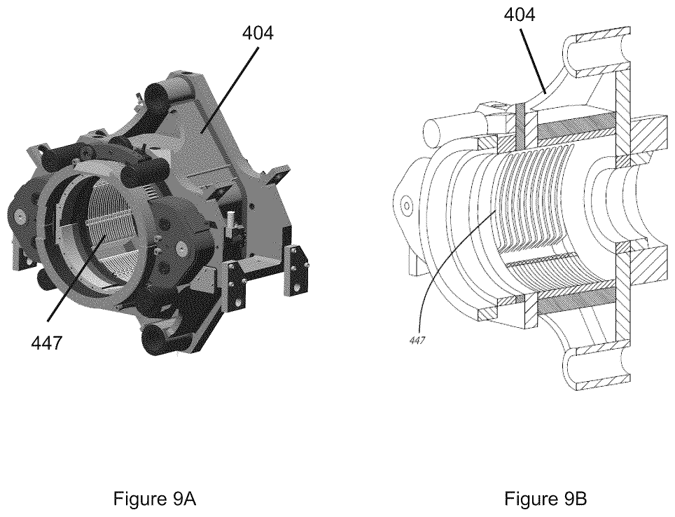

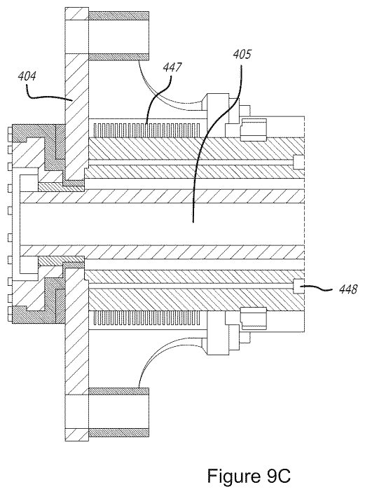

Referring to FIGS. 9A and 9B, the container holder 404 may incorporate various internal structural systems that enable the coordinated application of rotational forces and thermal conditioning during commercial-scale shear assisted direct extrusion operations. The internal configuration of the container holder 404 may reveal multiple chambers and passages that accommodate mechanical drive components, heating systems, and sealing arrangements that facilitate the controlled operation of the container body 405 during processing operations. In some cases, the container holder 404 may be configured with concentric structural elements that provide both mechanical support for rotating components and thermal management capabilities that enable controlled heating of the container body 405 and contained billet material. The structural arrangement within the container holder 404 may facilitate the integration of rotational drive systems with heating components while maintaining proper alignment and operational control throughout the extrusion cycle. The sealing ring 451 may be positioned within the container holder 404 to provide sealing functions between adjacent surfaces while accommodating both axial and rotational motion during operation.

As further shown in FIG. 9C, the container assembly 401 may incorporate thermal management systems that enable controlled heating of the container body 405 and the contained billet material to facilitate processing operations and reduce the force requirements associated with material deformation. An interior heater 448 may be positioned within the container body 405 to provide direct thermal input to the billet material and the internal surfaces of the container body 405 during setup and processing operations. In some cases, the interior heater 448 may be configured to operate during machine standstill periods or transition times to preheat the container body 405 and the billet material to desired processing temperatures before the initiation of extrusion operations. The interior heater 448 may provide controlled thermal conditioning that reduces the time associated with achieving proper processing temperatures and may enhance the material flow characteristics during the subsequent extrusion process. The positioning of the interior heater 448 within the container body 405 may enable direct heat transfer to the billet material while maintaining proper clearances and operational safety during heating operations.

The activation and control of the interior heater 448 may be facilitated through the integration of a heater plug 449 that provides electrical connection and control interface functions for the heating system. The heater plug 449 may be configured for manual connection and disconnection procedures that enable operators to activate the interior heater 448 during appropriate phases of the processing cycle. In some cases, the heater plug 449 may be designed for hand operation, enabling operators to establish electrical connection to the interior heater 448 during preheating operations and to disconnect the heater plug 449 during active extrusion processing when the interior heater 448 may not be in use. The heater plug 449 may incorporate features that provide secure electrical connection while enabling rapid engagement and disengagement procedures that facilitate efficient operation and maintenance activities. The electrical interface provided by the heater plug 449 may enable the interior heater 448 to receive controlled electrical power input that corresponds to the thermal conditioning requirements for different billet materials and processing conditions.

The thermal management capabilities within the container holder 404 may extend beyond the interior heater 448 to include additional heating systems that provide comprehensive temperature control throughout the container assembly 401. In some cases, the container holder 404 may include external heating elements 447 that surround the container body 405 and provide continuous thermal input during active extrusion operations to maintain desired processing temperatures and prevent heat loss to the surrounding environment. The external heating systems 447 within the container holder 404 may operate with power consumption in the kilowatt ranges, with heating capabilities that may be greater than or equal to about 30 kW or about 50 kW depending on the size and thermal requirements of the specific processing application. The integration of both interior and external heating systems within the container holder 404 may enable comprehensive thermal management that facilitates controlled material conditioning during both preheating and active processing phases of the extrusion cycle. The coordinated operation of multiple heating systems may provide enhanced temperature uniformity and processing control while reducing the overall time associated with achieving and maintaining proper processing conditions for various billet materials and geometries.

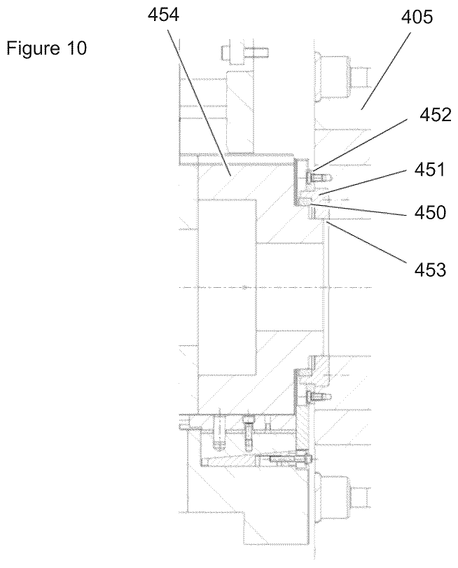

With reference to FIG. 10, the sealing ring 451 may be incorporated within the container assembly 401 to provide comprehensive sealing functions between rotating and stationary components while accommodating the complex motion patterns associated with shear assisted direct extrusion processing. The sealing ring 451 may be positioned at interfaces between the container body 405 and adjacent structural elements within the container holder 404 to prevent the leakage of lubricating fluids, hydraulic fluids, or billet material during operation. In some cases, the sealing ring 451 may be configured to maintain effective sealing performance while accommodating the rotational motion of the container body 405 and the axial forces that may be transmitted through the container assembly 401 during extrusion operations. The sealing ring 451 may incorporate materials and design features that enable the sealing ring 451 to withstand the elevated temperatures and pressures that may be encountered during commercial-scale processing while maintaining dimensional stability and sealing effectiveness throughout the operational cycle. The positioning of the sealing ring 451 within the multi-layered container structure may provide sealing functions between individual container layers while accommodating the thermal expansion and mechanical deformation that may occur during high-temperature processing operations.

Referring to FIG. 10, the shear assisted extrusion press 400 may incorporate sealing and wear ring systems that provide comprehensive sealing functions between rotating and stationary components during commercial-scale extrusion operations. The sealing systems may be configured to prevent the flow of molten metal between the container body 405 and adjacent die components while accommodating the rotational motion that occurs during shear assisted direct extrusion processing. In some cases, the sealing arrangements may be positioned at interfaces where the rotating container body 405 meets stationary die assemblies, creating potential pathways for material leakage that may compromise the extrusion process and operational safety. A centering ring 450 may be incorporated within the sealing system to provide alignment and positioning functions for die components relative to the container body 405 during operation. The centering ring 450 may be configured to maintain proper radial positioning of die elements while accommodating the rotational motion of the container body 405 and the substantial forces that may be generated during commercial-scale processing operations.

The mechanical arrangement of the sealing system may incorporate a centering ring 450 that provides additional alignment and structural support functions within the sealing assembly. In some cases, the centering ring 450 may be shrink-fitted within the sealing ring 451 to establish a secure mechanical coupling that maintains proper positioning and alignment during the varying load conditions that may occur during extrusion processing. The shrink-fit arrangement between the centering ring 450 and the sealing ring 451 may provide enhanced structural stability while enabling the coordinated positioning of sealing components relative to the rotating container body 405. A retaining ring 452 may be positioned within the sealing assembly to provide secure attachment of the centering ring 450 to the container holder 404, thereby establishing the structural foundation for the sealing system operation. The retaining ring 452 may serve as a mechanical fastening element that maintains the position of the centering ring 450 while accommodating the thermal expansion and mechanical deformation that may occur during high-temperature extrusion operations.

With continued reference to FIG. 10, a tool holder 454 may be positioned within the sealing system to provide structural support and alignment functions for die components that interface with the rotating container body 405 during extrusion operations. The centering ring 450 may serve to center the tool holder 454 relative to the container body 405, thereby maintaining proper alignment between die components and the contained billet material during processing operations. In some cases, the tool holder 454 may be configured to accommodate various die geometries and configurations while maintaining proper sealing performance at the interface with the rotating container body 405. The positioning of the tool holder 454 relative to the centering ring 450 may enable precise control over the alignment and clearances between die components and the container body 405, thereby facilitating effective material flow control during the extrusion process. A seal gap 453 may be maintained between the container body 405 and the tool holder 454 to provide controlled separation that prevents direct contact between rotating and stationary components while minimizing the potential for material leakage during high-pressure extrusion operations.

The seal gap 453 may be configured to maintain a constant distance between the rotating container body 405 and the stationary tool holder 454 throughout the extrusion cycle, thereby providing consistent sealing performance while accommodating the thermal expansion and mechanical deformation that may occur during processing operations. In some cases, the seal gap 453 may be dimensioned to provide adequate clearance for rotational motion while minimizing the pathway available for molten metal flow between the container body 405 and adjacent die components. Additional bearings may provide additional support and positioning functions that contribute to the maintenance of proper seal gap 453 dimensions during operation under substantial loads. The sealing system may operate in coordination with other bearing components within the container assembly 401 to maintain consistent clearances and alignment conditions that facilitate effective sealing performance throughout the extrusion process. The integration of the seal gap 453 with the centering ring 450, the sealing ring 451, the retaining ring 452, and the tool holder 454 may provide comprehensive sealing capabilities that prevent material leakage while accommodating the complex motion patterns associated with shear assisted direct extrusion processing.

The sealing and wear ring systems may be implemented in multiple configurations that accommodate different die geometries and processing requirements associated with various extrusion applications. The sealing systems may include radial sealing and wear ring arrangements that provide sealing functions through radial contact or proximity between rotating and stationary components. In some cases, radial sealing configurations may incorporate wear rings of various sizes that accommodate different container body 405 diameters and die geometries while maintaining effective sealing performance under the substantial pressures and temperatures associated with commercial-scale extrusion processing. The radial sealing arrangements may be positioned to provide sealing functions at interfaces where the container body 405 meets die components through radial engagement or controlled clearance arrangements. Conical sealing and wear ring configurations may provide alternative sealing approaches that utilize angled or tapered interfaces between rotating and stationary components to achieve effective sealing performance while accommodating the rotational motion of the container body 405.

The wear rings incorporated within both radial and conical sealing configurations may be fabricated from specialized materials that provide enhanced resistance to the elevated temperatures and mechanical stresses associated with molten metal contact during extrusion operations. In some cases, the wear rings may be constructed from iron-nickel alloys that may withstand high temperatures greater than or equal to about 600° C., thereby providing operational durability under the thermal conditions that may be encountered during the processing of various metallic materials. The iron-nickel alloy composition of the wear rings may provide enhanced thermal stability and mechanical strength characteristics that enable the wear rings to maintain dimensional stability and sealing effectiveness even when exposed to molten aluminum or other metallic materials during extrusion processing. The material properties of the iron-nickel alloy wear rings may enable extended operational life and reduced maintenance requirements compared to wear rings fabricated from conventional materials that may not provide adequate resistance to high-temperature molten metal exposure. The selection of iron-nickel alloys for wear ring construction may facilitate reliable sealing performance while minimizing the potential for premature wear or failure that might otherwise compromise the sealing system effectiveness during commercial-scale processing operations.

The hydrostatic axial bearing system may provide comprehensive support and positioning capabilities for the container assembly during commercial-scale shear assisted direct extrusion operations that involve the simultaneous application of substantial axial forces and rotational motion. In some cases, the hydrostatic bearing system may be configured to accommodate extrusion forces that may be greater than or equal to about 35 MN while maintaining proper separation and alignment between rotating and stationary components throughout the processing cycle. The hydrostatic bearing system may utilize pressurized fluid to create controlled separation between adjacent surfaces, thereby reducing friction and wear while enabling smooth rotational motion under the demanding load conditions associated with large-scale commercial processing operations. The integration of hydrostatic bearing technology within the container assembly may enable the coordinated application of both axial containment forces and rotational shear forces while maintaining the precision and operational control that may be associated with effective shear assisted direct extrusion processing.

The operational principles of the hydrostatic axial bearing system may involve the controlled introduction of pressurized fluid between bearing surfaces to establish a fluid film that separates rotating components from stationary structural elements during operation. In some cases, the pressurized fluid within the hydrostatic bearing system may be maintained at pressure levels that correspond to the magnitude of the axial forces being transmitted through the container assembly, thereby ensuring adequate load support while preventing direct contact between moving surfaces. The fluid film established by the hydrostatic bearing system may provide both load-bearing capabilities and lubrication functions that facilitate smooth rotational motion even under the substantial force conditions that may exceed 35 MN during commercial-scale extrusion operations. The pressurized fluid may be supplied through controlled flow systems that maintain consistent pressure and flow characteristics throughout the extrusion cycle, thereby providing stable bearing performance even as the loading conditions vary during the processing of different billet materials and geometries.

The structural arrangement of the hydrostatic axial bearing system may incorporate multiple bearing surfaces and fluid distribution channels that enable uniform load distribution and consistent separation between rotating and stationary components during operation. The bearing surfaces may be configured with specialized geometries and surface treatments that optimize fluid flow patterns and pressure distribution characteristics while accommodating the thermal expansion and mechanical deformation that may occur during high-temperature processing operations. In some cases, the fluid distribution channels within the hydrostatic bearing system may be arranged to provide controlled fluid flow to multiple bearing zones, thereby enabling localized pressure control and enhanced load distribution capabilities across the bearing interface. The bearing surfaces may incorporate features such as recessed pockets, grooves, or other geometric modifications that facilitate fluid retention and pressure maintenance while accommodating the rotational motion of the container assembly during shear assisted extrusion processing.

The fluid supply and control systems associated with the hydrostatic axial bearing system may provide precise regulation of bearing pressure and flow characteristics to maintain optimal bearing performance under varying operational conditions. The fluid supply system may incorporate pumps, pressure regulators, and flow control valves that enable real-time adjustment of bearing operating parameters in response to changes in extrusion force, rotational speed, or processing temperature during commercial-scale operations. In some cases, the fluid supply system may be configured to maintain bearing pressure at levels that provide adequate load support while minimizing fluid consumption and power requirements associated with bearing operation. The control systems may incorporate feedback mechanisms that monitor bearing performance parameters such as fluid pressure, flow rate, and bearing clearance to enable automatic adjustment of operating conditions and early detection of potential bearing system issues that might affect operational reliability.

The load-bearing capabilities of the hydrostatic axial bearing system may enable the container assembly to withstand the substantial reaction forces that develop during direct extrusion processing while maintaining proper alignment and rotational capability throughout the processing cycle. The bearing system may be configured to distribute axial loads across multiple bearing zones or contact areas, thereby reducing localized stress concentrations and enhancing the structural durability of the bearing interface under high-force conditions. In some cases, the load distribution characteristics of the hydrostatic bearing system may enable the container assembly to accommodate extrusion forces that may reach or exceed 35 MN while maintaining consistent bearing clearances and rotational performance. The bearing system may incorporate features that enable automatic load balancing and pressure adjustment in response to varying force conditions, thereby maintaining optimal bearing performance even as the extrusion forces fluctuate during the processing of different billet sizes or material compositions.

The thermal management aspects of the hydrostatic axial bearing system may address the elevated temperature conditions that may be encountered during commercial-scale extrusion processing while maintaining proper bearing fluid properties and performance characteristics. The bearing fluid may be selected to provide stable viscosity and lubrication properties across the temperature range associated with extrusion operations, thereby ensuring consistent bearing performance even as the container assembly and surrounding components experience thermal cycling during processing operations. In some cases, the hydrostatic bearing system may incorporate cooling or temperature control features that maintain bearing fluid temperature within optimal operating ranges while accommodating the heat generation that may result from friction, fluid shear, and thermal conduction from adjacent heated components. The thermal management capabilities of the bearing system may enable extended operational periods and enhanced bearing life while maintaining the precision and reliability that may be associated with commercial-scale shear assisted direct extrusion processing applications.

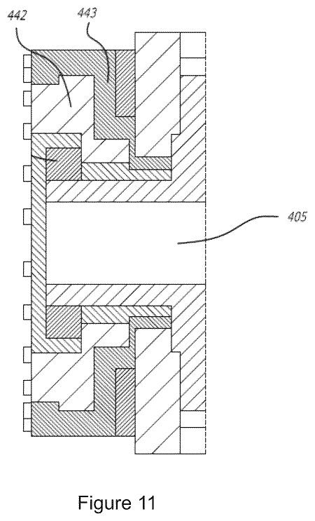

Referring to FIG. 11, the hydrostatic axial bearing 442 mates with the container 405. During the extrusion process, the container 405, the hydrostatic axial bearing 442, and the billet rotate. The stationary hydrostatic axial bearing 443 stays stationary during extrusion. Hydraulic fluid can be filled between the rotating hydrostatic axial bearing 442 and the stationary hydrostatic axial bearing 443 to facilitate the rotational movement when the large extrusion force is applied to the billet while the container 405 rotates. The hydraulic motors for rotating drive 445 and the gear unit 446 drive the rotation. The rotating container 405 and the hydrostatic axial bearing assembly 442 and 443 do not move axially.

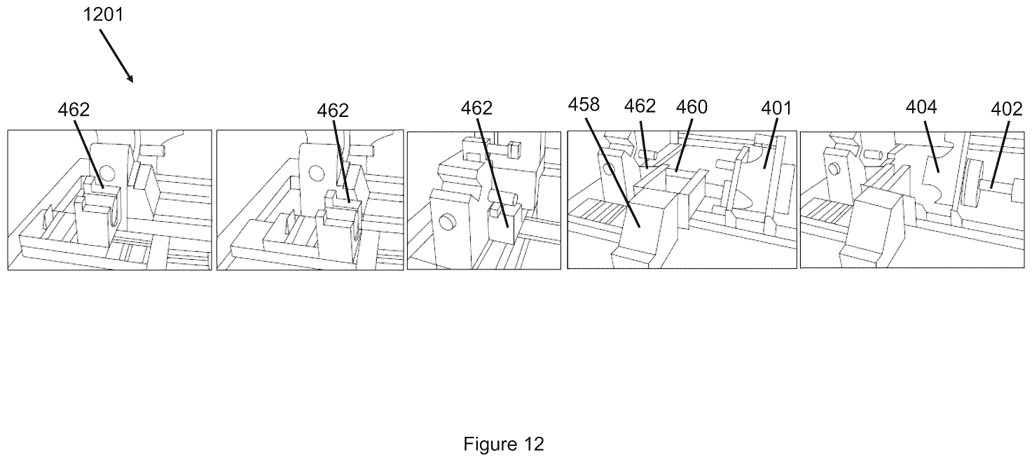

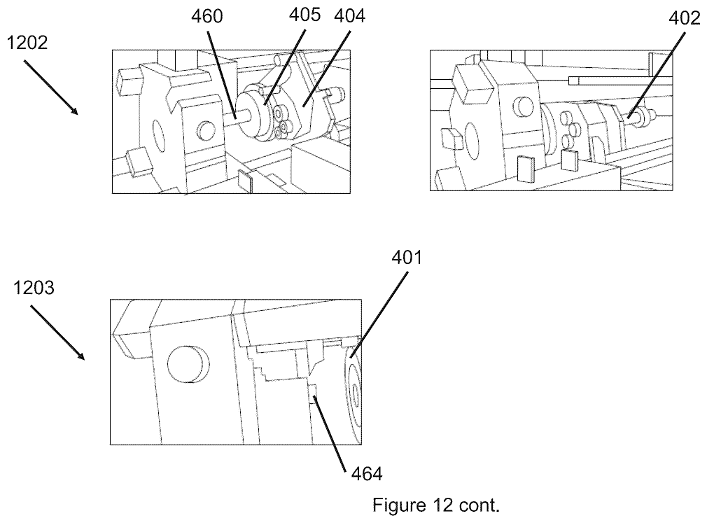

Referring to FIG. 12, the shear assisted direct extrusion process may involve a coordinated sequence of operational phases that enable the controlled application of both axial forces and rotational shear forces during commercial-scale manufacturing operations. The process may begin with a step that involves loading (1201) the billet 460 material into the container assembly 401 using a billet loading tool 458 and positioning the billet material 460 for subsequent processing operations. In some cases, the billet loading step may involve the coordinated movement of the container assembly 401 to a position that enables access for billet 460 insertion and proper alignment with the extrusion stem 402 and associated die components 462. The billet material may comprise various metallic compositions including aluminum, iron, copper, silicon, magnesium, manganese, zinc, chromium, nickel, titanium, and zirconium, with aluminum alloys from the 3xxx, 5xxx, 6xxx, 7xxx series, and 8xxx series being particularly suitable for shear assisted processing applications. The billet material may be provided in various physical forms including powder, flake, scrap, wire, and solid billet materials, thereby enabling the processing of both virgin materials and recycled feedstocks that may contain compositional inhomogeneities or intermetallic compounds that would otherwise limit their suitability for conventional extrusion processes.

In some cases, before loading the billet material, the die assembly can be preheated to a desired temperature to shorten the extrusion process and improve efficiency. The preheated die assembly can be loaded and aligned into the extrusion press. The billet can be preheated to a desired temperature before being transferred to the extrusion press. The preheat temperature may vary depending on the billet material, the extrude geometries, and/or extrusion processing parameters.

The billet loading step (1201) may involve the precise positioning of the container assembly 401 relative to the extrusion stem 402 to enable proper engagement between the stem assembly 406 and the billet material 460 during subsequent processing operations. In some cases, the container holder 404 may be moved to a retracted position that provides clearance for billet insertion while maintaining proper alignment with the die assembly and associated tooling components 462. The container body 405 may be positioned to receive the billet material and may provide the structural containment that enables the application of both axial forces and rotational shear forces during the extrusion process. The billet material 460 may be positioned within the container body 405 such that the billet material interfaces properly with the extrusion stem 402 and maintains proper alignment with the die opening through which material flow will occur during the extrusion operation. The loading step may also involve the positioning of dummy blocks or other interface components that facilitate the transmission of forces from the extrusion stem 402 to the billet material while accommodating the rotational motion that characterizes shear assisted processing.

Following the completion of billet loading operations, the process may proceed to a step that involves the coordinated application of axial forces and rotational motion to achieve controlled material deformation and flow through the die assembly. The extrusion step (1202) may involve the simultaneous operation of the stem plunger assembly 408 to generate substantial axial forces while the rotational drive systems within the stem drive 407 and the container assembly 401 provide controlled rotational motion to the billet material 460. In some cases, the main piston 412 within the stem plunger assembly 408 may generate axial forces that push the extrusion stem 402 forward, thereby applying linear extrusion forces to the billet material contained within the container body 405. The rotary piston 414 may rotate during the extrusion process to impart rotational motion to the extrusion stem 402, while the container body 405 may simultaneously rotate through the operation of the radial piston motor 445 and the gear unit 446 to provide coordinated shear forces to the billet material. The combination of axial forces and rotational motion may result in severe plastic deformation of the billet material, leading to microstructural refinement and enhanced material flow characteristics that enable the processing of lower-grade feedstocks and the production of extruded products with improved mechanical properties.

The extrusion step (1202) may involve the controlled progression of the billet material through the die opening while maintaining proper coordination between the axial movement of the extrusion stem 402 and the rotational motion of both the stem assembly 406 and the container assembly 401. In some cases, the hydraulic bearing 403 and associated bearing systems may provide the mechanical support that enables smooth rotational motion while accommodating the substantial axial loads that may be generated during commercial-scale processing operations. The sealing ring 451 and associated sealing components may prevent material leakage while accommodating the complex motion patterns that result from the simultaneous application of linear and rotational forces. The extruded part that emerges from the die assembly may have various geometries including cylinders, cubes, cuboids, pyramids, prisms, cones, and spheres, and may be configured as either solid or hollow structures depending on the specific die geometry and processing parameters employed during the extrusion operation. The extruded part may achieve diameters of at least about 5, 6, 7, 8, 9, 10, 15, or 20 inches for commercial scale production applications, thereby enabling the manufacture of large-scale structural components and other products that may not be achievable through conventional laboratory-scale shear assisted extrusion processes.

Upon completion of the material flow and extrusion operations, the process may proceed to a step that involves the removal (1203) of die components and the separation of the extruded part from any remaining billet material or discard portions 464. The die removal (1203) step may involve the coordinated movement of the extrusion stem 402 and the container assembly 401 to their initial positions while maintaining proper control over the extruded part and any associated discard material. In some cases, the stem drive 407 may coordinate the retraction of the extrusion stem 402 while the container holder 404 moves to a position that enables access to the die assembly and the completed extrusion. The rotational motion of both the stem assembly 406 and the container assembly 401 may continue during the retraction process to facilitate the separation of the extruded part from the die assembly and to enable the controlled removal of any discard material that remains attached to the die components. The die removal step (1203) may also involve the operation of shearing mechanisms that separate the extruded part from discard portions 464, with the discard material 464 being directed to appropriate collection systems through chutes or conveyor arrangements that facilitate material handling and recycling operations.

The coordinated operation of the rotational drive systems during the die removal step (1203) may facilitate the clean separation of the extruded part while minimizing material waste and enabling the efficient preparation of the apparatus for subsequent processing cycles. The hydraulic rotary piston motor 425 and associated drive components within the stem drive 407 may continue to provide controlled rotational motion during the retraction process, while the radial piston motor 445 within the container assembly 401 may coordinate the rotational motion of the container body 405 to facilitate material separation and die cleaning operations. In some cases, the gear wheel 427 and associated transmission components may provide the mechanical coupling that enables precise control over the rotational motion during both the extrusion and die removal phases of the process cycle. The thrust bearing 403 and the roller bearing 417 within the stem plunger assembly 408 may accommodate the varying load conditions that occur during the transition from high-force extrusion operations to the lower-force die removal and preparation phases of the process cycle.

The integration of rotational motion with axial movement throughout the complete process cycle may enable the achievement of the severe deformation conditions that characterize shear assisted direct extrusion while maintaining operational control and material quality throughout the manufacturing operation. The coordinated operation of the stem assembly 406 and the container assembly 401 may provide the combined loading conditions that result in microstructural refinement and enhanced material properties in the final extruded product. In some cases, the rotational motion imparted by both the extrusion stem 402 and the container body 405 may create controlled shear zones within the billet material that promote grain refinement, intermetallic breakdown, and compositional homogenization that enable the use of recycled or scrap feedstocks to produce high-quality extruded products. The process may be repeated for subsequent billets through the coordinated return of all system components to their initial loading positions, thereby enabling continuous manufacturing operations that combine the productivity advantages of commercial-scale processing with the material quality enhancements associated with shear assisted deformation mechanisms. The extrusion process can be repeated a number of times until the die needs to be replaced.

In several embodiments, the extruded part can be processed with additional processes and/or steps such as machining, polishing, heat treatment, anodizing, to achieve the desired geometries, structural properties, mechanical properties, and/or appearance.

A number of implementations have been described. Nevertheless, it will be understood that various modifications may be made without departing from the spirit and scope of the disclosure. Accordingly, other implementations are within the scope of the following claims.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the,” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. Where ranges are described, the range should be understood to include the endpoints of the ranges, and the endpoints of such ranges are also contemplated to stand on their own as inventive, individual data points and to form the endpoints of other ranges. For example, a ratio in the range of about 1 to about 200 should be understood to include the explicitly recited limits of about 1 and about 200, but also to include individual ratios such as about 2, about 3, and about 4, sub-ranges such as about 1 to about 10, about 10 to about 50, about 20 to about 100, about 100 to about 200, and so forth, and related ranges such as greater than about 1 or less than about 200.

What is claimed is:

1. An axial stem bearing system for a shear assisted extrusion press, comprising:
a rotary piston configured to rotate while transmitting axial forces during extrusion operations;
a thrust bearing positioned to accommodate the axial forces transmitted through the rotary piston, wherein the axial forces are configured to enable an axial motion of the rotary piston;
a hydraulic bearing configured to provide support and positioning while maintaining controlled separation between rotating and stationary components using pressurized fluid; and
a plurality of roller bearings arranged to provide radial support and positioning for the rotary piston while enabling a rotational motion under load, wherein the thrust bearing, the hydraulic bearing, and the plurality of roller bearings operate in coordination to provide comprehensive support for the rotary piston during simultaneous axial and rotational motion.

2. The axial stem bearing system of claim 1, wherein the hydraulic bearing utilizes pressurized lubricating fluid to maintain controlled clearances between the rotary piston and adjacent stationary components.

3. The axial stem bearing system of claim 2, wherein the pressurized lubricating fluid maintains consistent clearances even as loading conditions vary during extrusion operations.

4. The axial stem bearing system of claim 1, wherein the thrust bearing is configured to accommodate axial forces greater than or equal to 20 MN.

5. The axial stem bearing system of claim 4, wherein the thrust bearing is configured to accommodate axial forces greater than or equal to 35 MN.

6. The axial stem bearing system of claim 1, wherein the plurality of roller bearings are arranged to distribute radial loads across multiple contact points to reduce contact stresses.

7. The axial stem bearing system of claim 6, wherein the plurality of roller bearings remain stationary and provide sealing functions that separate the rotary piston from lubricating fluids.

8. The axial stem bearing system of claim 1, wherein the rotary piston is configured to rotate while the thrust bearing remains stationary during extrusion operations.

9. The axial stem bearing system of claim 8, wherein rotating parts including the rotary piston and hydraulic bearing operate independently of stationary parts including the roller bearings and thrust bearing.

10. The axial stem bearing system of claim 1, wherein the hydraulic bearing is configured to create a dynamic and self-correcting separation between rotating and stationary components.

11. The axial stem bearing system of claim 10, wherein the hydraulic bearing maintains separation through pressurized fluid that adjusts to varying load conditions during operation.

12. The axial stem bearing system of claim 1, wherein the thrust bearing provides a load-bearing interface between hydraulic force generation components and rotating elements of the system.

13. The axial stem bearing system of claim 12, wherein the thrust bearing enables transmission of axial forces while accommodating rotational motion of the rotary piston.

14. The axial stem bearing system of claim 1, wherein the plurality of roller bearings are positioned to maintain the rotary piston in proper axial and radial alignment during rotational motion under load.

15. The axial stem bearing system of claim 14, wherein the plurality of roller bearings enable smooth rotational motion while providing structural support necessary to maintain proper alignment under substantial forces generated during commercial-scale extrusion processing.

16. The axial stem bearing system of claim 1, wherein the coordinated operation of the thrust bearing, the hydraulic bearing, and the plurality of roller bearings facilitates simultaneous handling of substantial axial loads and rotational torques while maintaining precision and control necessary for effective shear assisted extrusion processing.

17. The axial stem bearing system of claim 16, wherein the bearing system maintains operational reliability and longevity under the complex loading conditions associated with commercial-scale direct extrusion operations.

18. The axial stem bearing system of claim 1, wherein the shear assisted extrusion press extrudes a part with a diameter of greater than or equal to 7 inches.

19. The axial stem bearing system of claim 1, wherein the axial forces are greater than or equal to 20 MN.
